(19) United States
(12) Patent Application Publication
(10) Pub. No.: US 2017/0052696 A1
(43) Pub. Date: Feb. 23, 2017

(54) ADAPTING COMPUTER FUNCTIONALITY BASED ON HANDWRITING ENERGY EXPENDITURE

(71) Applicant: Sharon L. Oviatt, Bainbridge Island, WA (US)

(72) Inventor: Sharon L. Oviatt, Bainbridge Island, WA (US)

(21) Appl. No.: 15/240,942

(22) Filed: Aug. 18, 2016

Related U.S. Application Data
(60) Provisional application No. 62/283,095, filed on Aug. 19, 2015.

(51) Int. Cl. G06F 3/0488; G06F 3/041

(52) U.S. Cl. CPC G06F 3/04883; G06F 3/0416

(57) ABSTRACT

Techniques are described for automatically assessing and using a user's handwritten input on a computing device to modify further user interactions, such as to dynamically adapt additional information that is presented to reflect an automatically assessed knowledge level of the user for a given subject area, and/or to dynamically adapt a user interface on the computing device to reflect an automatically assessed amount of energy expenditure of the user in producing the handwritten input. The techniques may include assessing the total energy expenditure of a user in producing handwritten input, by measuring and evaluating metadata about the handwritten input such as multiple stroke-level signal features, and combining them to determine an assessed total energy expenditure of a user, and may further include automatically assessing a knowledge level of the user for a subject area of the handwritten input based on the assessed total energy expenditure of the user.

### CROSS-REFERENCE TO RELATED APPLICATIONS

This application claims the benefit of U.S. Provisional Patent Application No. 62/283,095, filed Aug. 19, 2015 and entitled “System And Method For Predicting Domain Expertise Based On Total Energy Expenditure During Handwriting,” which is hereby incorporated by reference in its entirety.

### TECHNICAL FIELD

The following disclosure relates generally to techniques for automatically assessing and using handwritten input to a computing device to modify further user interactions, such as to use total energy expenditure of a user in producing handwritten input to assess a knowledge level of the user for a subject area and to adapt further user interactions based on the assessed knowledge level.

### BACKGROUND

Many computing devices, such as smartphones, tablets, laptops, smart watches, etc., accept user input based on writing, such as on a touch-sensitive screen of the device or other input area on which such writing may be performed and have corresponding information made accessible to the device. However, various difficulties exist with designing and developing devices with usable interfaces for effectively accepting and processing handwritten input.

In addition, when interacting with a user regarding a subject area, various benefits may be obtained if the user's knowledge of that subject area was known. However, various difficulties exist with assessing a user's knowledge of a subject area in a manner that is reliable, rapid, objective, non-intrusive, and acceptable to users.

Accordingly, it would be beneficial to provide improved methods of obtaining and using handwritten input from users, and of assessing and using a user's knowledge of a subject area.

### BRIEF DESCRIPTION OF THE DRAWINGS

FIG. 1 is a network diagram illustrating an example environment in which a system for assessing and using handwritten input to a computing device to modify further user interactions may be used, including illustrating example computing systems suitable for executing an embodiment of such a system.

FIGS. 2A-2D are diagrams illustrating examples of assessing and using handwritten input to a computing device to modify further user interactions.

FIGS. 3A-3K are diagrams illustrating further examples of assessing and using handwritten input to a computing device to modify further user interactions.

FIG. 4 illustrates a flow diagram of an example embodiment of a Handwriting Energy Expenditure (HEE) System routine.

FIG. 5 illustrates a flow diagram of an example embodiment of a HEE User Handwriting Assessment Component routine.

FIG. 6 illustrates a flow diagram of an example embodiment of a HEE User Assessment Tracking And Analysis Component routine.

FIG. 7 illustrates a flow diagram of an example embodiment of a HEE User Interaction Adaptation Component routine.

### DETAILED DESCRIPTION

Techniques are described for automatically assessing and using handwritten input by a user to a computing device to modify further user interactions. In some embodiments, the modification of further user interactions based on a user's handwritten input may be performed dynamically while the user interacts with the computing device (e.g., in a single interaction session), such as to dynamically adapt additional information that is presented to the user to reflect an automatically assessed knowledge level of the user for a given subject area, and/or to dynamically adapt a user interface or other displayed information on the computing device to reflect an automatically assessed amount of energy expenditure of the user in producing the handwritten input. In other embodiments, the modification of further user interactions based on handwritten input of one or more users to one or more computing devices may be performed in other manners, as discussed in greater detail below.

The assessment and use of a user's handwritten input to a computing device may be performed in various manners, and in at least some embodiments includes assessing the total energy expenditure of a user in producing handwritten input, such as by measuring and evaluating metadata about the handwritten input (rather than the content of the handwritten input). In particular, a particular handwritten input from a user may include a sequence or series of strokes, with each stroke including a series of measured points as a handwriting input tool (e.g., a stylus, a finger, etc.) moves on a touch-sensitive input area from a start (or ‘down’) point to an end (or cup′) point to form one or more characters (e.g., digits, symbols, letters, etc.), portions of characters, diagrams, etc. The metadata for such handwritten input may include various stroke-level signal features (also referred to herein as “signal level features” and “stroke signal features”), such as, for example, average stroke pressure (e.g., the mean pressure or force applied by a user when writing individual strokes from input tool down to input tool up), average stroke duration (e.g., the mean duration of individual pen strokes from input tool down to input tool up), average stroke distance (e.g., the mean distance of individual pen strokes from input tool down to input tool up), etc., including in some situations to aggregate individual metadata values for each of some or all of the measured stroke points. After the stroke-level signal features are measured for a user, they may be combined in various manners to determine an assessed total energy expenditure value (or “score”) of a user in forming a stroke and/or a group of multiple strokes. Additional details are included below regarding assessing the total energy expenditure of a user in producing handwritten input.

The assessment and use of a user's handwritten input to a computing device may, in at least some embodiments, further include automatically assessing a knowledge level of the user for a subject area of the handwritten input based at least in part on the assessed total energy expenditure of the user in producing the handwritten input. The assessment of the knowledge level may, in at least some embodiments, be performed without using any information about the content of the handwritten input (e.g., without using any information about a lexical or dialogue level of the content, such as total number of words written per concept, average length of noun phrase descriptions, etc.; without using any information about accuracy or correctness of the user's handwritten answers to questions about the subject area; etc.) and without using any other information about the user's knowledge level, such as to instead use only the assessed total energy expenditure of the user—in other embodiments, information about the assessed total energy expenditure of the user may be used in combination with one or more other types of information (e.g., lexical or dialogue level of the content, accuracy or correctness of the user's handwritten, other domain-specific markers, etc.), as discussed in greater detail below. The assessment of the user's knowledge level based on the assessed total energy expenditure may reflect, for example, that lower total energy level is associated with higher knowledge level in an inverse relationship, and may in some embodiments include using a determined mapping between particular total energy levels and particular associated knowledge levels. Additional details are included below regarding assessing a knowledge level of a user for a subject area of handwritten input from the user based at least in part on the assessed total energy expenditure of the user in producing the handwritten input.

As noted above, further interactions with one or more users may be adapted based at least in part on an assessment of handwritten input by the user(s), such as based on assessed knowledge levels for the user(s) and/or determined total energy expenditure (“TEE” or “TE”) scores for the user(s). As one example, while a user interacts with a computing device and provides handwritten input, the further interactions (e.g., in a single interaction session) may include dynamically adapting further information presented to the user and/or further functionality made available to the user—such further interaction adaptation may be useful as part of, for example, giving a student or a job applicant a test with questions of variable difficulty levels, presenting a reader with a level of information that corresponds to their knowledge level, etc. As another example, while a user interacts with a computing device and provides handwritten input, the further interactions (e.g., in a single interaction session) may include dynamically adapting a user interface on the computing device to reflect an automatically assessed amount of energy expenditure of the user in producing the handwritten input, such as to change the size or location of an input area on the screen for the handwritten input, or to adjust the system's ink feedback corresponding to what the user wrote (e.g., the visual representation of the ink stroke size and line thickness of displayed ink feedback in response to the user's writing pressure, stroke size and/or other signal features during their writing used to calculate total energy expended), to reduce an amount of energy expended by the user when writing and also reduce their writing space on small computer screens. As yet another example, information may be gathered from one or more users and used in manners other than a dynamic adaptation of content and/or a user interface, such as to assess the usability of one or more particular handwritten input tools (e.g., a stylus and/or touch-sensitive screen, a smart pen that includes sensors to identify handwritten input and measure its stroke-level signal features for handwriting on a piece of paper or other surface, etc.) based at least in part on an amount of energy expended by the user(s) in providing the handwritten input using the particular handwritten input tool(s). In addition, information from multiple users may be gathered and aggregated, such as to enable a teacher to evaluate learning of a group of students, or to otherwise compare or evaluate a group of multiple users. Additional details are included below regarding adapting further interactions with one or more users based at least in part on an assessment of handwritten input by the user(s).

The described techniques for assessing and using handwritten input to a computing device to modify further user interactions may be performed by an automated Handwriting Energy Expenditure (HEE) system in at least some embodiments. Such an HEE system may, in some embodiments, be executed in part or in whole on a client computing device with which a particular user is interacting, such as to enable the HEE system to dynamically adapt output of the client computing device for the user (whether alone or by interacting with one or more other programs that are interacting with the user). In addition, such an HEE system may, in some embodiments, be executed in part or in whole on one or more server computing devices that are in communication (e.g., wirelessly, over one or more computer networks, etc.) with one or more other client computing devices with which one or more users are interacting, such as to enable the HEE system to obtain information from multiple users for use in comparison or aggregation, and/or to dynamically adapt interactions with particular users based on their user-specific attributes. Additional details regarding embodiments of such an HEE system are included below.

The described techniques may provide a variety of benefits and advantages. Non-exclusive examples of such benefits and advantages include the following: improving operations of client computing devices in efficiently displaying information and interacting with users; improving operations of systems that are analyzing usability of particular handwritten input tools, in order to produce and provide more efficient and effective tools; improving knowledge acquisition and assessment by particular users by dynamically adapting interactions with them; improving handwritten input generation by users, by reducing an amount of energy used to generate the handwritten input; etc.

The following provides non-exclusive illustrative examples of embodiments that assess and use handwritten input to one or more computing devices to modify further user interactions in particular manners, such as by using total energy expenditure of a user in producing handwritten input to assess a knowledge level of the user for a subject area and to adapt further user. It will be appreciated that the described techniques may be used with a wide variety of other situations, some of which are further discussed below, and that the invention is not limited to the techniques discussed. For illustrative purposes, some embodiments are described below in which specific types of operations are performed, including with respect to using the described techniques with particular types of handwritten input tools, client devices and/or server devices in particular manners. These examples are provided for illustrative purposes and are simplified for the sake of brevity, and the inventive techniques may be used in a wide variety of other situations, including in other environments and with other types of automated control action determination techniques, some of which are discussed below.

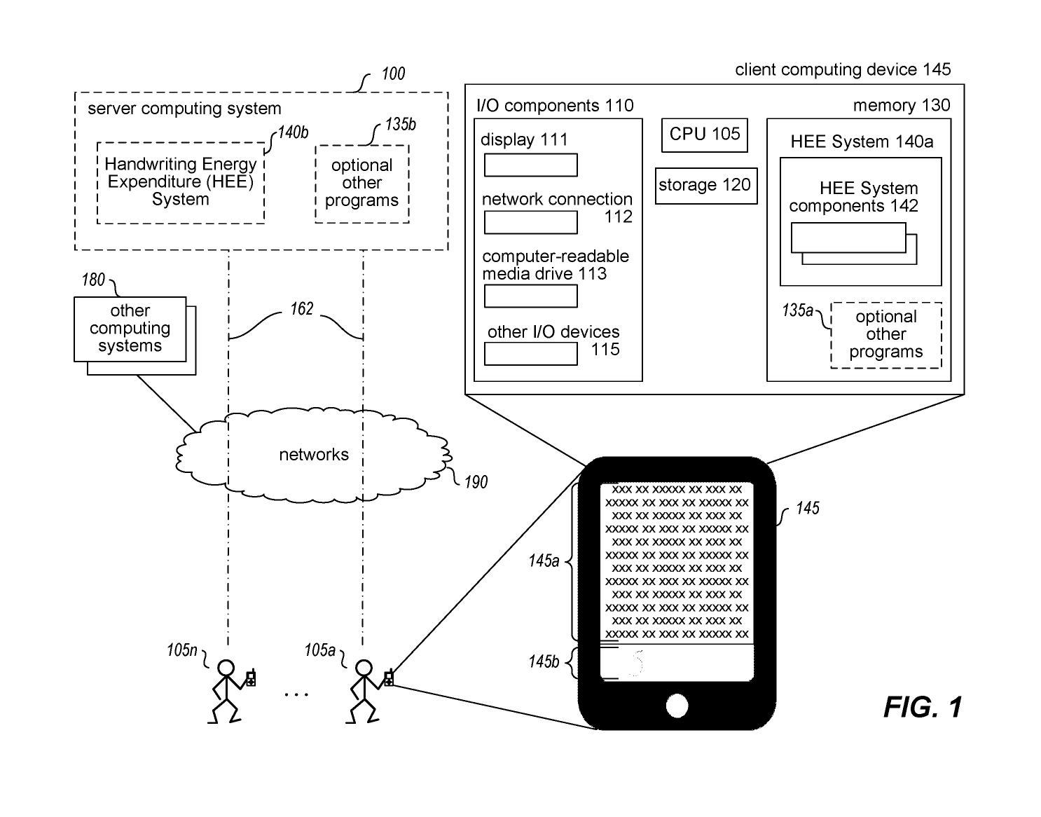

FIG. 1 is a network diagram illustrating an example environment in which a system for assessing and using handwritten input to a computing device to modify further user interactions may be used, including illustrating example computing systems suitable for executing an embodiment of such a system.

In particular, FIG. 1 illustrates example users 105 who each has a client computing device in use by the user, such as a portable device on which the user can provide handwritten input for further use in the described system for assessing and using such handwritten input. The handheld client device 145 of example user 105a is illustrated in additional detail, such as to include a tablet device and/or smartphone device with a touch-sensitive display. In this example, the display is separated into sections 145a and 145b by a graphical user interface (“GUI”) displayed on the device 145, with the portion 145b being used in this example for the user to provide handwritten input, and the separate portion 145a being used to display or otherwise present various information to the user. It will be appreciated that in other embodiments the user may be allowed to provide handwritten input on any portion of the touch-sensitive input screen (e.g., over displayed information, such as if the GUI does not provide a separate area for handwritten input). In yet other embodiments, a user may provide handwritten input in other manners, such as on a separate device (e.g., if the device 145 does not include a touch-sensitive area), via a digital pen device (also referred to as a “smartpen”, with pens from ANOTO being one example) in which the device includes information for sensing the handwritten input (e.g., on ordinary paper), etc.

In the illustrated embodiment, additional details are further shown regarding example internal components of the client device 145. In particular, in this example, client device 145 is suitable for performing at least some of the described techniques, such as by executing an embodiment of a Handwriting Energy Expenditure (HEE) system 140a, as discussed further below. The example device 145 includes one or more central processing unit (“CPU”) processors 105, various input/output (“I/O”) components 110, storage 120, and memory 130. Illustrated I/O components in this example embodiment include a display 111 (to provide the visual display area 145a and 145b), a network connection 112, a computer-readable media drive 113, and other I/O devices 115 (e.g., wireless or attached keyboards, mice or other pointing devices, microphones, speakers, cameras, pressure sensors, etc.)

An optional server computing system 100 and one or more other network-accessible computing systems 180 are also illustrated, and may each have internal components similar to those of client device 145, although corresponding details are not illustrated in this example for the sake of brevity. In embodiments in which the device 145 includes wireless communications capabilities (e.g., WiFi, a cellular connection, Bluetooth, etc.), the device 145 may communicate with some or all of the other computing systems 100 and 180 over one or more intervening networks 190, such as to perform interactions 162 with the server computing system 100 to provide information about some or all handwritten input received from the user on the client device 145. In other embodiments, such interactions may instead occur in manners other than via wireless communications, such as to perform such interactions at a later time via a wired or cabled connection (e.g., if the client computing system 145 does not include wireless communications, and/or if the HEE System 140b later performs its analysis in an offline or batch mode).

In the illustrated example, one or more embodiments of the HEE System 140 may be in use to perform some or all of the described techniques, such as a copy 140a that is executing in memory 130 of the client device 145. The HEE System 140 may further include one or more HEE System components 142, as is illustrated with respect to system copy 140a, and as discussed in greater detail below—HEE System copy 140b on server computing system 100, if present, may similarly include one or more such components, although they are not illustrated in FIG. 1. In such embodiments in which a copy 140a of the HEE System is executing on the client device 145, the HEE system 140a may assess and use the handwritten input provided by user 105a in the section 145b of the display, such as in a real time or near-real time manner, including to dynamically adjust further interactions with the user on the client device 145 (and/or on other devices with which the user 105a interacts) based on the handwritten user input. As discussed in greater detail elsewhere, such further interactions may include modifying information displayed in the section 145a of the screen, modifying the visual representation of the handwritten input in area 145b, modifying the GUI to change the size and/or location of the input area 145b, etc. The client device 145 may further execute one or more optional other programs 135a, such as to provide information to or otherwise interact with the user 105a, optionally in conjunction with the HEE System 140a (e.g., to adapt the interactions with the user based on assessments provided by the HEE system).

In some embodiments, a copy of the HEE System 140 may execute on one of the other computing systems, such as on optional server computing system 100 in the illustrated example, whether in addition to or instead of a copy of the HEE System 140a on the client computing device 145. In the illustrated example, such a server computing system 100 may interact with one or more users 105, such as to receive information about handwritten input on client devices of the users and to perform some or all of the described techniques, whether in addition to or instead of HEE system copies executing locally on the client devices of the users. Such an optional server computing system 100 may further execute one or more optional other programs 135b, such as that provides information to or otherwise interacts with the users 105, optionally in conjunction with the HEE System 140b (e.g., to adapt the interactions with the user based on assessments provided by the HEE system).

Additional details regarding operations of embodiments of the HEE System are included below.

It will be appreciated that the illustrated computing systems and device are merely illustrative and are not intended to limit the scope of the present invention. For example, network 190 may include portions of the Internet, a private network (e.g., a corporate network), a cellular network, or any other networks, including combinations of one or more such networks. In addition, computing system 100 and/or client device 145 may be connected to other devices that are not illustrated, including through one or more networks such as the Internet or via the Web. More generally, a “client” or “server” computing system or device may comprise any combination of hardware that can interact and perform the described types of functionality, such as when programmed or otherwise configured with software, including without limitation desktop computers, laptop computers, slate computers, tablet computers, embedded computers, specialized hardware such as ASICs (“application-specific integrated circuits”) or other computers, smart phone computing devices and other cell phones, Internet appliances, PDAs and other electronic organizers, database servers, network storage devices and other network devices, wireless phones, pagers, television-based systems (e.g., using set-top boxes and/or personal/digital video recorders and/or game consoles and/or media servers), and various other consumer products that include appropriate inter-communication capabilities. For example, the illustrated system 140 and/or its components may include executable software instructions and/or data structures in at least some embodiments, which when loaded on and/or executed by particular computing systems or devices may be used to program or otherwise configure those systems or devices, such as to configure processors of those systems or devices. Alternatively, in other embodiments, some or all of the software components and/or systems may execute in memory on another device and communicate with the illustrated computing system/device via inter-computer communication. In addition, while various items are illustrated as being stored in memory or on storage at various times (e.g., while being used), these items or portions of them can be transferred between memory and storage and/or between storage devices (e.g., at different locations) for purposes of memory management and/or data integrity. Furthermore, the functionality provided by the illustrated system components may in some embodiments be combined in fewer components or distributed in additional components. Similarly, in some embodiments the functionality of some of the illustrated components may not be provided and/or other additional functionality may be available.

Thus, in at least some embodiments, the illustrated components and/or systems are software-based components/systems including software instructions that, when executed by the CPU(s) 105 and/or CPU(s) of system 100 and/or other processor means, program the processor(s) to automatically perform the described operations for that component/system. Furthermore, in some embodiments, some or all of the components and/or systems may be implemented or provided in other manners, such as at least partially in firmware and/or hardware means, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the systems, components or data structures may also be stored (e.g., as software instructions contents or structured data contents) on a non-transitory computer-readable storage medium, such as a hard disk or flash drive or other non-volatile storage device, volatile or non-volatile memory (e.g., RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted as generated data signals (e.g., as part of a carrier wave or other analog or digital propagated signal) on a variety of computer-readable transmission mediums, including wireless-based and wired/cable-based mediums, and can take a variety of forms (e.g., as part of a single or multiplexed analog signal, or as multiple discrete digital packets or frames). Such computer program products may also take other forms in other embodiments. Accordingly, the present invention may be practiced with other computer system configurations.

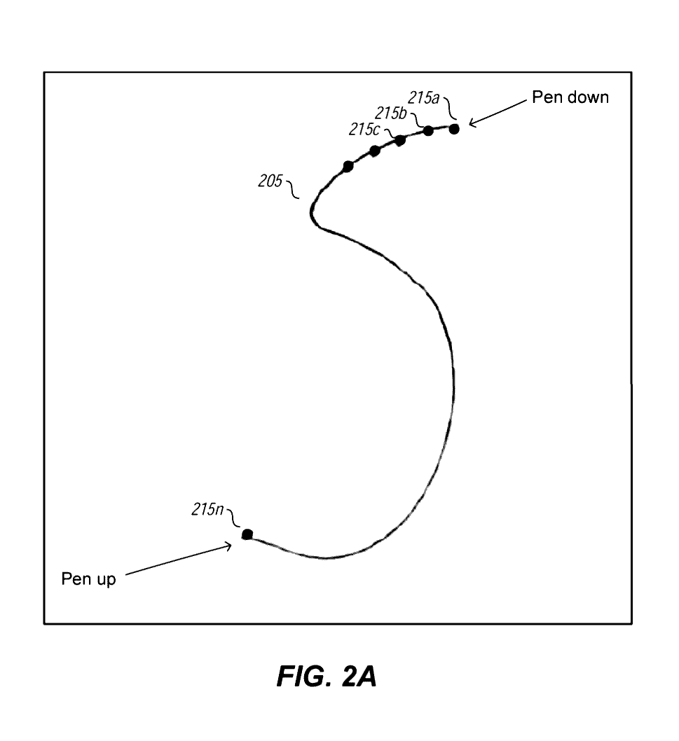

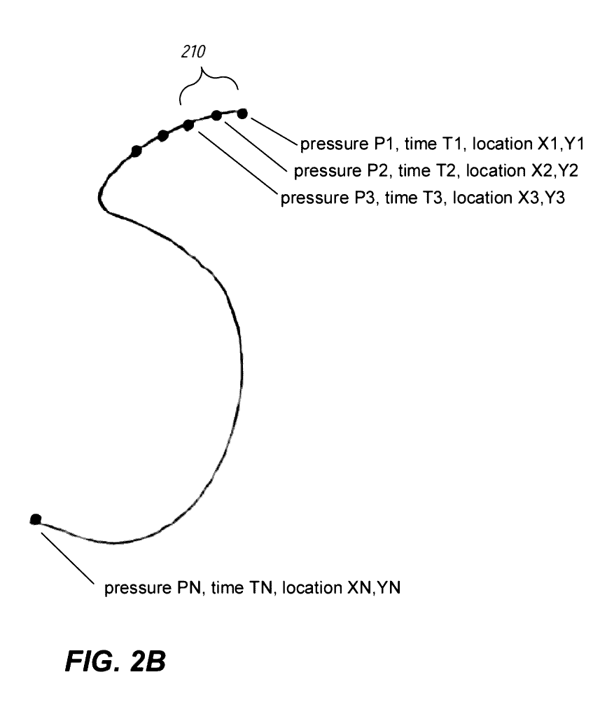

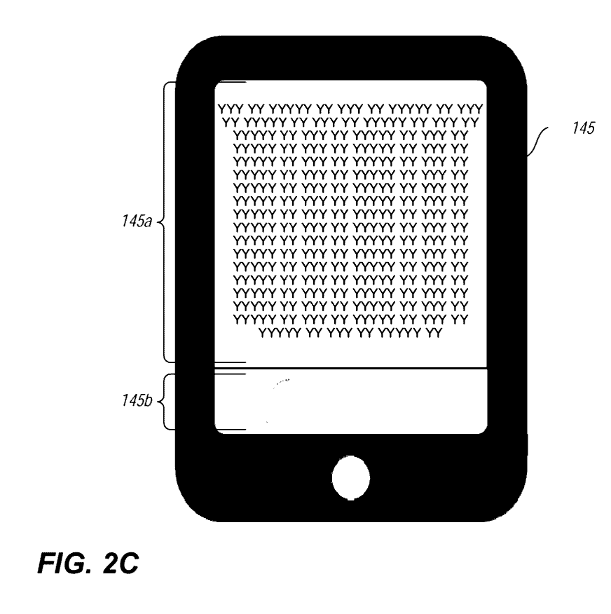

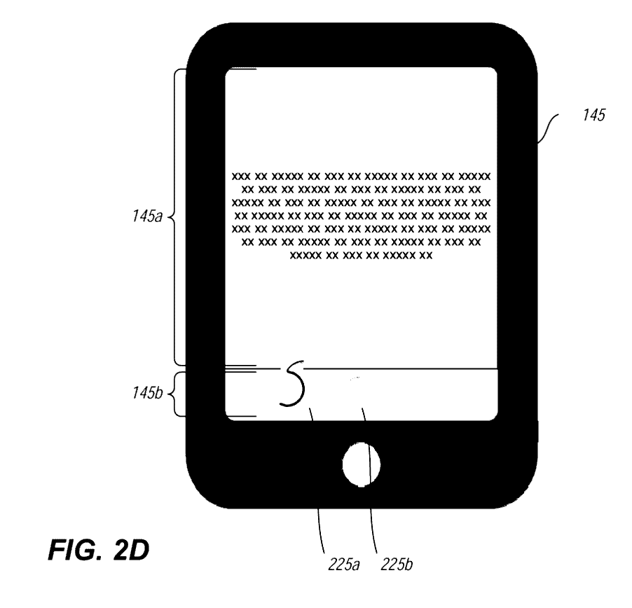

FIGS. 2A-2D are diagrams illustrating examples of assessing and using handwritten input to a computing device to modify further user interactions.

In particular, FIG. 2A illustrates an example of handwritten input that a user (e.g., user 105a of FIG. 1) may supply on a client device (e.g., device 145 in FIG. 1) or in another manner, which in this example includes a single stroke 205 that represents a character ‘S’. In the illustrated example, the stroke is recorded by the client device 145 or other recording device as a series of points 215, with each point having associated metadata (e.g., location information, such as x,y coordinates in a coordinate system of the display or other input area; a recording of axial pressure, or z; etc.). The points include an initial point 215a that corresponds to the beginning of the stroke 205, or “pen down”, followed by an endpoint 215n at the end of the stroke, or “pen up”. While only a limited number of example points are shown in FIG. 2A for the point of illustration, it will be appreciated that large numbers of points (e.g., 10 s, 100 s, 1000 s, etc.) may be obtained for a particular stroke.

As discussed in greater detail elsewhere herein, stroke signal features may be determined for some or all of the stroke 205, including the following: distance of the stroke, such as a length in millimeters or other distance metric from the first point after pen down until the last point before pen up; duration of the stroke 205 in milliseconds or other time metric, from the first point after pen down until the last point before pen up; pressure of the stroke 205, such as the average axial pen pressure Z across all points sampled in the stroke, such as measured in Newton (N) units of force or other pressure metric (in which z typically bears a nonlinear relation to N); etc. It will be appreciated that different hardware devices and computer systems may use different sensors with respect to one or more of the signal feature measurements, such as pressure—if so, the measurements and use of such features may in some embodiments be performed in a manner specific to a particular device, optionally after using a baseline or other normalization technique as discussed further below. After appropriate normalization, data from multiple different devices may be aggregated or otherwise used together, such as for comparison (e.g., as part of a usability study for different devices). In addition, in some systems, the pen pressure range that is recorded (e.g., from minimum to maximum detectable units) can be adjusted for an individual user's habitual written pressure, such as lighter versus harder, and if so such data can further be used in a similar normalized manner in such embodiments.

FIG. 2B continues the example of FIG. 2A, and illustrates that each of the stroke data points 215 may include various associated measured information as noted above, such as the initial stroke point 215a having an associated pressure P1, time T1, and location X1, Y1, while the last point 215n similarly has an associated pressure PN, time TN, and location XN, YN. In addition, determining stroke-level features such as, for example, total distance, may be performed in various manners in various embodiments. For example, to measure the distance 210 between initial point 215a and later point 215c, the distance may be estimated in some embodiments by determining a straight line distance between the location X1, Y1 of point 215a and location X3, Y3 of point 215c. Alternatively, for a more accurate distance estimate, one or more intermediate points, such as 215b in this example, may be further used as part of the distance determine (e.g., to determine the distance from point 215a to 215b, the distance from point 215b to 215c, and then add them together to use as an estimate of the distance from point 215a to point 215c). It will be appreciated that other types of distance determinations may be used in other embodiments, including curve fitting and other integration techniques.

FIG. 2C continues the example illustrated with respect to FIG. 1 and FIGS. 2A-2B. In particular, in the example of FIG. 1, the illustrated client device 145 contains various information illustrated in its display portion 145a, which in this example is illustrated in FIG. 1 as various characters (“XXX XX . . . ”), although it will be appreciated that the presented information may have various forms (e.g., one or more of text, images, video, audio, etc.). FIG. 2C illustrates one example of a dynamic modification that may be made to further interactions with the user based on an assessment of the user's handwritten input in the area 145b of the client device 145, such as to assess a level of knowledge of the user with respect to a corresponding subject matter, and to modify the information displayed in section 145a of the computing device 145 accordingly. In this example of FIG. 2C, the information in section 145a has been modified in such a manner, with the modified information illustrated (“YYY YY . . . ” in this example).

FIG. 2D continues the previous examples, and illustrates two additional types of dynamic adaptations of further user interactions that may be performed, whether together or separately, based on an assessment of the handwritten input of the user in section 145b. In particular, in the example of FIG. 2D, the information illustrated in section 145a has remained the same as previously illustrated in FIG. 1, but an assessment of the total energy used by the user in providing the handwritten input 225a may result in dynamically adapting the graphical user interface or other information displayed on the device. For example, if it is determined that the user is using a higher amount of total energy in generating the stroke 205 (illustrated in FIG. 2D with visual representation 225a), the described techniques may in some embodiments modify the visual representation of that stroke, such as to use lighter or narrower lines as illustrated in alternative visual representation 225b, so that a user thereafter is encouraged to generate similar handwriting input using less total energy. In addition, whether in addition to or instead of such dynamic modifications of the visual representations of the handwritten input, the described techniques may include dynamically modifying the graphical user interface to modify the portion 145b that is used for receiving the handwritten input, such as in the illustrated example to make the input area smaller (e.g., to use less space on smaller screens), and with a size of the alternative visual representation 225b reflecting the smaller size (e.g., for use with further handwritten input). While the example of FIG. 2D includes making the input area smaller, in other embodiments and situations the input area instead may be made larger, such as to provide the user with additional room when writing future letters in the larger space. It will be appreciated that one or both of these types of information adaptation may be used in some embodiments, optionally together with one or more other types of dynamic adaptation (e.g., the content adaptation discussed with respect to FIG. 2C), while in other embodiments one or more of the adaptations illustrated with respect to FIGS. 2C and 2D may not be used.

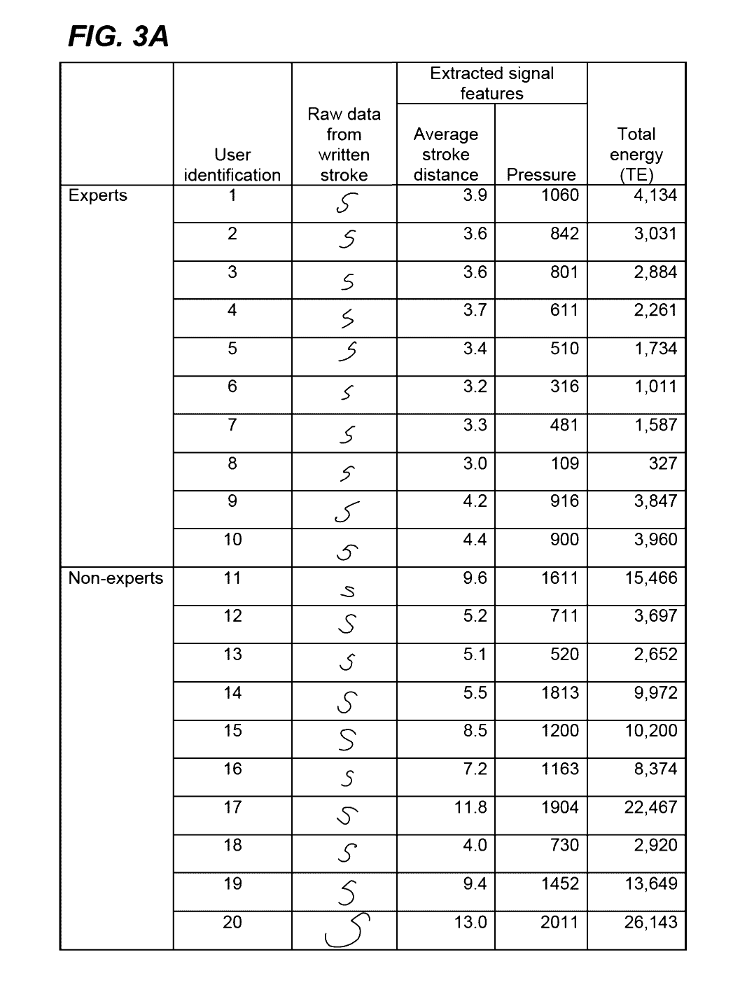

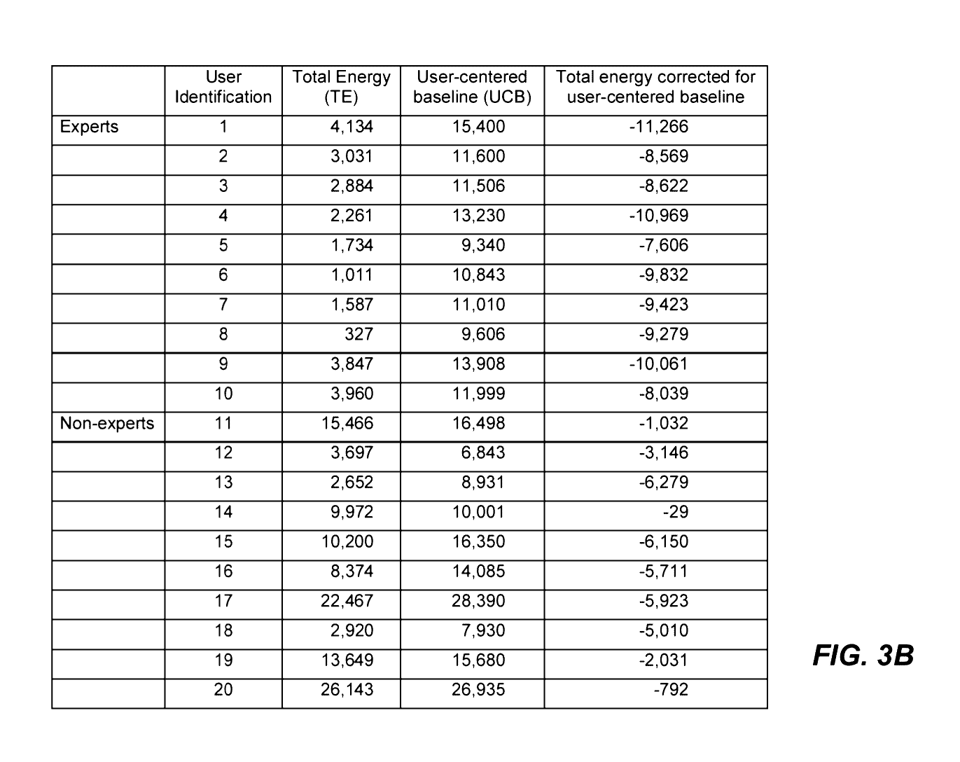

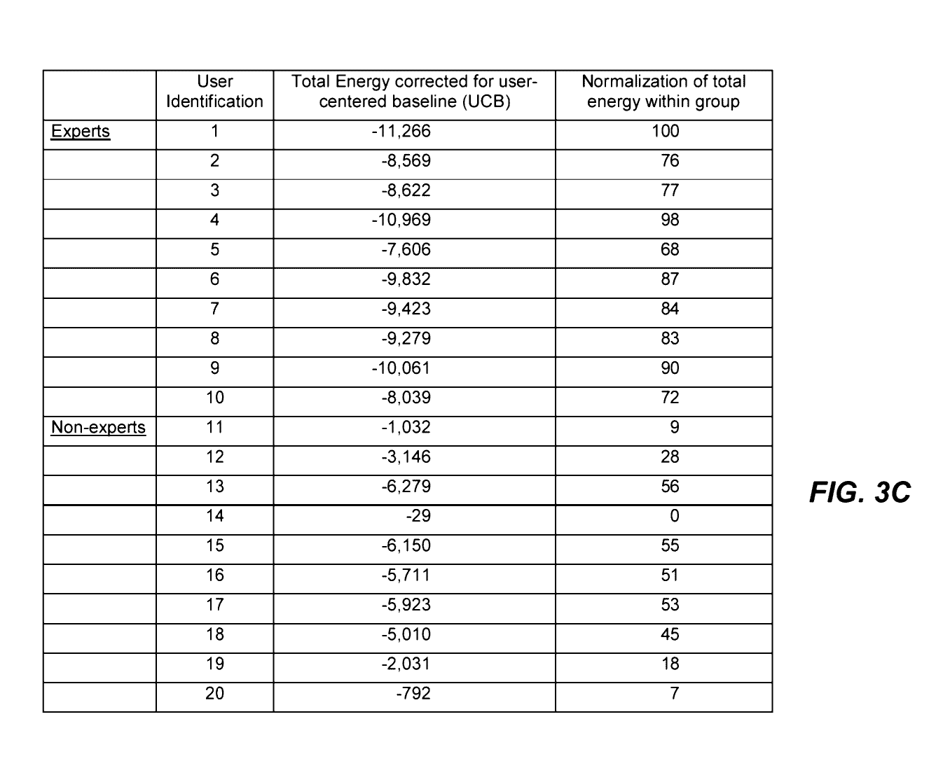

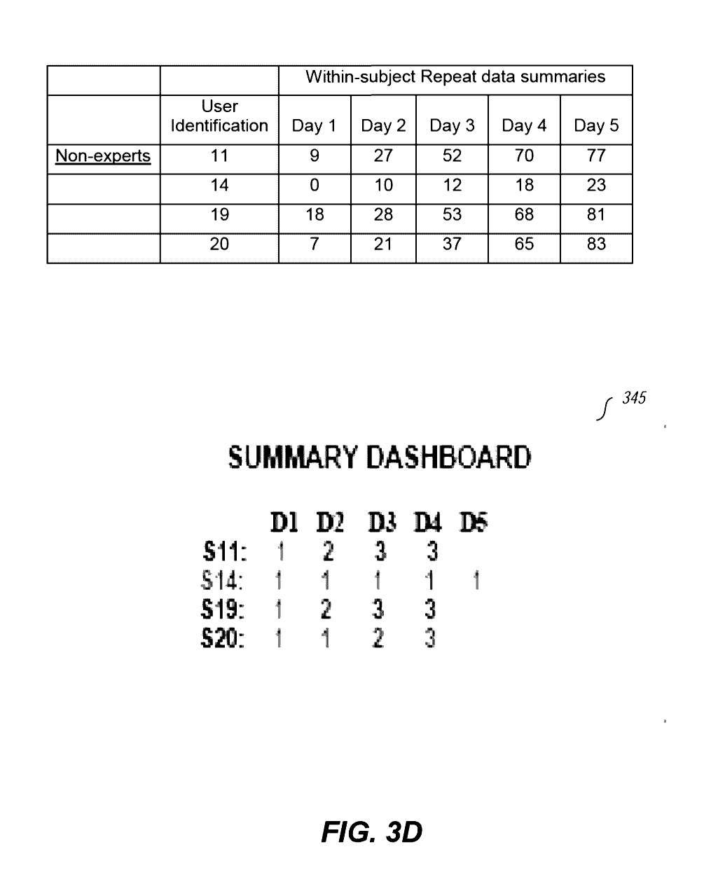

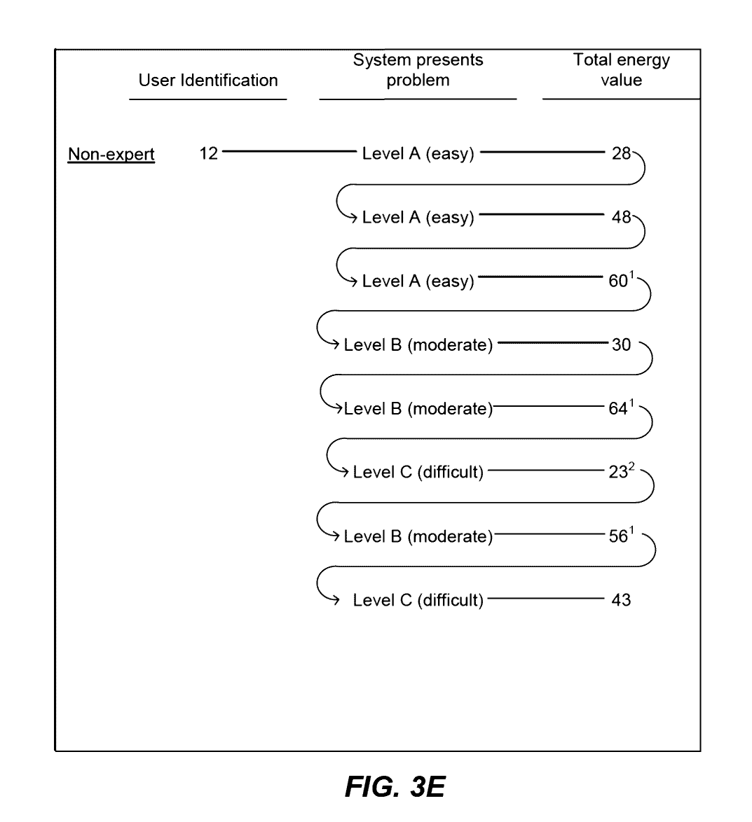

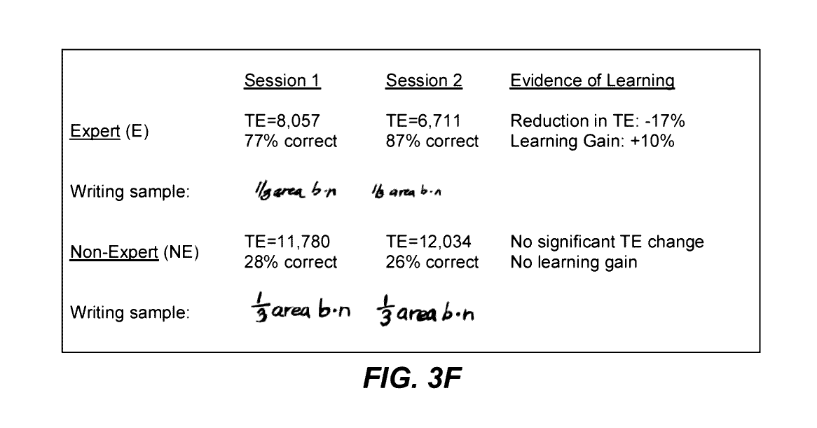

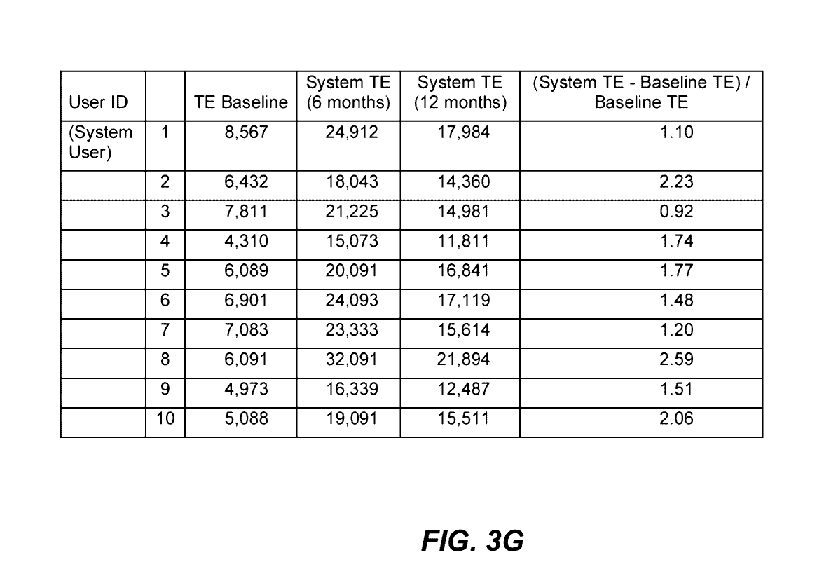

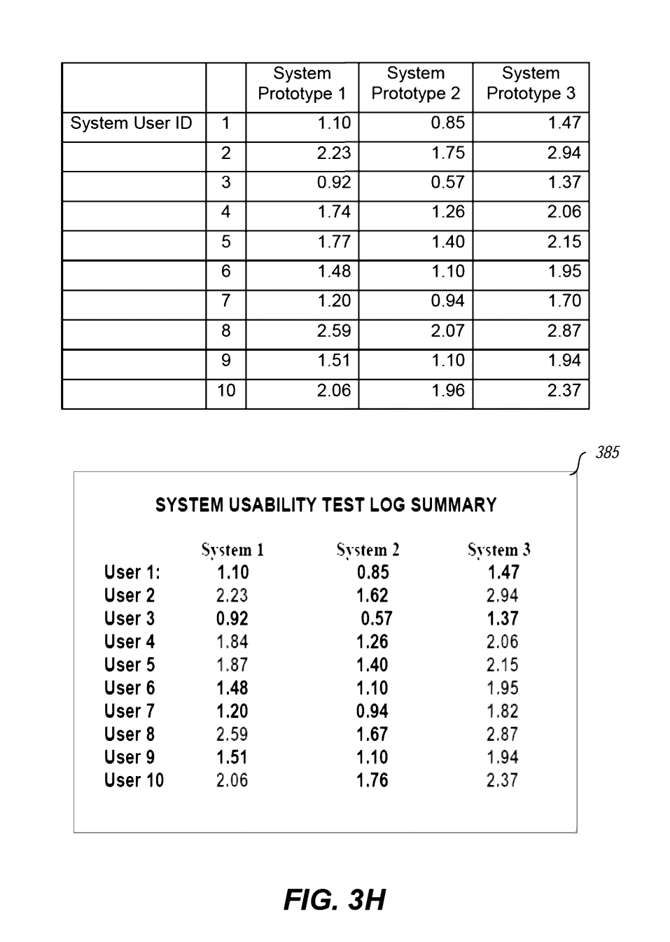

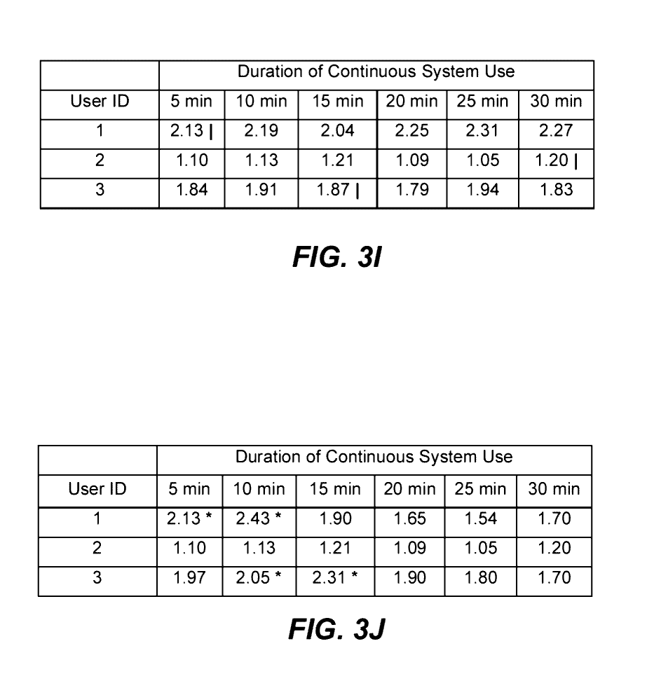

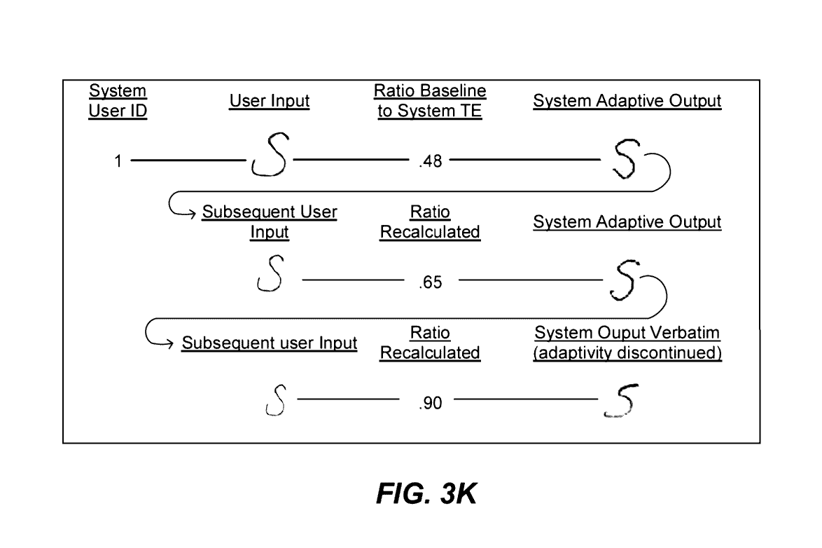

FIGS. 3A-3K are diagrams illustrating further examples of assessing and using handwritten input to a computing device to modify further user interactions.

In particular, FIGS. 3A-3B illustrate examples of summarizing information about a TE metric for multiple users, such as by analyzing a batch of data at one point in time, or instead continuously or repeatedly as data is collected to provide real-time estimates (e.g., based on rolling averages).

In the example of FIG. 3A, data is illustrated from a number of different users, which in this example include 10 domain expert users and 10 non-expert users for the subject area domain, with respect to a single written stroke for the letter “S”. As is illustrated in the columns, different stroke differences and stroke level feature values may be present for different users, including with respect to stroke distance and pressure, and an illustrated example of a total energy determination for the stroke based on those two stroke signal features is further illustrated. In this example, distances are represented in millimeters, and pressure is represented as axial pen pressure (e.g., to estimate a force with 2,056 levels of sensitivity in this example). Total energy in this example is determined based on a straight forward multiplication of stroke distance and pressure. In other embodiments, the TE composite score can be computed in other manners, such as using a different empirical model or instead machine learning techniques, or a hybrid combination of both.

FIG. 3B continues the example, and includes information about normalization of the total energy expended with respect to the various users shown in FIG. 3A for the example signal stroke handwritten input of that figure. In particular, each user in the example of FIG. 3B has a user-centered baseline based on other written input obtained from the user in a different subject matter domain for which they are a novice, and the total energy expended by each user is corrected with respect to their user-centered baseline. The corrected total energy values show a larger drop for the experts than for the non-experts in the target domain compared with the baseline. The user-centered baseline may be used in this manner to correct for a particular user's usual written signal features, such as sampling their writing in a domain in which the person is a complete novice. The hardware system used to gather the different handwritten inputs for the user-centered baseline and the current value being adjusted or normalized is preferably a single system.

FIG. 3C shows a process of normalizing an individual's TE score with the TE scores of other individuals in a defined group, for example students in a classroom or a group of job candidates. In this example, the group normalization is converted to a percentile representation, with the largest drops in total energy expenditure being shown as the highest values that are typical experts.

FIG. 3D further shows these normalized TE values for four individuals during repeated within-subject testing over five points in time, which permits comparison of later values with earlier values when learning progress is being assessed—these four individuals are selected in this example based on having the lowest normalized TE scores in FIG. 3C. FIG. 3D also illustrates an automatically generated visual analytic tool 345, summarized as a dashboard or other visual display or other presentation of information to guide teacher intervention—such TE assessment information may be used to monitor learning progress automatically, without explicitly taking tests. In the dashboard of FIG. 3D, information is shown as a simplified visual analytic, with performance values reduced to quartiles (1-4), and could also be color-coded for quick reference by a teacher (e.g., red, lowest quartile; green, second quartile; blue, third quartile; gold, top quartile). For example, student 14 may be highlighted (e.g., in red) as not progressing beyond the lowest quartile, which could guide the teacher to intervene with supplementary tutoring. Such a summary 345 may, for example, be generated for display to one or more users, such as the users involved in the generation of the data from the handwritten input and/or one or more other users (e.g., a teacher or manager, to aid in making decisions, such as whether and when to intervene by providing a student with instructional assistance, or determining whether a job candidate is adequately qualified for a particular position).

FIG. 3E illustrates the use of TE values to automatically adapt the content, difficulty level, or other aspects of problems presented to students to accommodate their level of competence during educational activities, automated testing, and similar computer-based activities. In particular, the individuals' TE scores have been normalized within a group, and the automatic adapting may be used, for example, during (a) teaching of new curriculum information, or (b) evaluation of a student's mastery of it. FIG. 3E further illustrates how different types of problems presented to a particular example user may correspond to different amounts of total energy used, such as based on the level of difficulty of the problem, with levels a, b, and c used in this example to describe problems of easy, moderate, and difficult levels, respectively. In this example, after a system defined threshold of a total energy value of 50 is exceeded (as illustrated in the examples with a “1” marking), the system presents a problem at a next highest difficulty level, such as to move from level a to level b. Conversely, if another threshold of a total energy value of 25 (as illustrated in the examples with a “2” marking) is exceeded in a downward fashion to be below the threshold the system instead presents a problem at the next lowest difficulty level, such as to move from level b to level a. It will be appreciated that other threshold values may be used in other situations.

FIG. 3F illustrates a comparative example of a user who is an expert (on the top) and a user who is not an expert (on the bottom), with each user having a handwritten input sample illustrated in a highlighted or indicated area. Each user has information received from two different handwriting samples (involving a math formula in this example), along with information about corresponding assessed total energy and results accuracy of the content represented by the handwritten input. Written strokes by the domain expert typically are smaller, briefer, and lighter in pressure than the non-expert. Over time, as the non-expert becomes a domain expert, her written strokes also will shift to become smaller, briefer, and lighter in pressure. This figure also shows that the total written energy (TE) of a domain expert is lower than a non-expert. Furthermore, when learning occurs between sessions 1 and 2 for the expert user, TE values correspondingly decrease. In contrast, the non-expert does not learn in this example, and her TE values likewise do not change. “Expert” versus “non-expert” designations may, for example, be defined and validated by habitual differences in their percentage of correctly solved problems within the domain (e.g., 77-87% for expert, versus 26-28% for non-expert).

FIG. 3G continues the example, and illustrates how information from different users may be used with respect to evaluating a particular hardware system over time to evaluate its usability, such as based at least in part on the total amount of energy expended by users in interacting with the hardware system (e.g., after six months of use versus after 12 months of use, with information illustrated in the right column to compare the total energy reduction after further use). In particular, total energy (TE) values for users are compared with a baseline, which in this case may be the same users writing with a digital pen on paper, compared with a screen-based computer being evaluated and with which the users received 12 months familiarization. The far right column summarizes the relative increase in total writing energy expended by users of the screen-based system, compared with the baseline paper surface. For example, user 10 showed a 206% relative increase in energy expenditure, or approximately 3-fold increase. Preferably, the different values for the different time periods correspond to a user providing handwritten input for the same type of content (e.g., composing email) after extended experience using the system during the indicated period of time. The indicated determination in the right-hand column of the comparison represents a relative increase in a user's total expended when using the computer system at 12 months compared with the baseline total energy for the user.

FIG. 3H continues the example, and in particular illustrates an example of usability testing of three different hardware systems by different users with respect to total energy expended and providing handwritten input on those systems, which summarizes users' relative increase in total energy expended when using each system compared with a baseline (e.g., writing on a paper surface). While not illustrated in FIG. 3H, various types of comparisons between the different systems could be performed, such as to indicate relative or absolute differences in amounts of total energy. It will be appreciated that the data for the different systems may be obtained over one or more defined periods of time, such as to have a substantially similar amount of time using each system in at least some embodiments. In addition, one of the example systems may in some embodiments be of an alternative type, such as handwriting on paper with a pen, or instead the different systems may be compared to a baseline using such a system or instead using a different existing and known hardware system for obtaining handwritten input. The different hardware systems may vary in different manners, such as different styluses, different handwriting auto-completion or other features, different touch-sensitive or other input areas, etc.

FIG. 3H also shows an automatically generated usability test summary 385 based on the logged data, with relative increases in users' total energy expenditure for different systems over baseline interpreted and displayed according to two risk thresholds: some values (e.g., to be shown in green) exceed user satisfaction levels (e.g., >1.80); and other values (e.g., to be shown in red) exceed both user satisfaction levels and exertion levels free of repetitive stress injury (RSI) symptoms (e.g., >2.00). These automatically collected and displayed data would be available to guide the selection of more successful commercial systems. In this example, system 1 and 3 testing revealed that 30-50% of cases exceeded RSI risk levels, and an additional 20-30% exceeded both user satisfaction and RSI risk levels, whereas system 2 remained under these risk thresholds for all cases tested. Such a test summary 385 may, for example, be generated for display to one or more users, such as the users involved in the generation of the data from the handwritten input and/or one or more other users (e.g., representatives of one or more of the hardware systems, such as for use in designing or improving the hardware systems), or instead an independent evaluator of all three systems. It will be appreciated that different thresholds may be used in different situations.

FIG. 3I continues the example, and illustrates tracking information that may be determined for different users with respect to use of a particular hardware system, such as in this example to track total amounts of energy used over different periods of time (e.g., a user's relative increase in total energy expended, such as compared with their baseline) that include 5 minutes, 10 minutes, 15 minutes, 20 minutes, 25 minutes and 30 minutes. In addition, the example of FIG. 3I illustrates that a system may provide different features at different times for different users, such as in this example to provide handwriting auto-completion based on the user's total energy used and duration of writing. In this example, the highest user's total energy levels triggers a system onset of auto-completion mode after five minutes (for user one, as illustrated with a vertical line to the right of the corresponding time period), while the system instead delays such onset until after 15 minutes for user three due to a moderately high total energy values for that user, and further delays the onset until after 30 minutes for user two based on relatively low levels of total energy output. This adaptive system capability is designed to conserve user energy while speeding up the interaction, and also to avoid user fatigue and RSI when using the system for extended periods. It will be appreciated that the thresholds used for such variations may be modified in various manners, such as tailored to reflect individual users' sensitivity, and/or to accomplish different defined goals of the hardware system.

FIG. 3J continues the example, and further illustrates an example of a system that suspends the system's use of handwritten input when a threshold of 2.0 total energy value (e.g., a user's relative increase in total energy expended, such as compared with their baseline) is exceeded, with the system resuming normal ink feedback when the total energy value drops below that threshold. In the example of FIG. 3J, the indication of the suspension of the system inking feature is illustrated with an asterisk to the right of the corresponding total energy value. Here the system automatically adapts ink feedback to display only when the user's values remain within a low to moderate range. This adaptive system capability is designed to train the user to avoid over-expending their total energy when using the system, so that the system can be used for longer continuous durations without fatigue. It will be appreciated that the threshold's use could be varied in various manners, including to be adapted to particular users with respect to their sensitivity to fatigue or RSI, or instead to accommodate other goals of the system. In some embodiments, methods of change detection other than fixed thresholds may be used.

FIG. 3K continues the example, and illustrates an example of a system that adapts the system output for handwritten information based on the amount of total energy used by a user (e.g., with respect to a user's relative increase in total energy expended, such as compared with their baseline). Here the system automatically adapts users' actual handwritten input to render the ink displayed on the system screen as their average ratio of TE during baseline compared to writing on the system. For example, user 1 previously was shown to have a 0.48 ratio, or a TE of 8,567 divided by 17,984. This shrinking of the displayed ink would include reduced size and finer lines. In this example, when the user's handwritten input total energy ratio of baseline to system total energy becomes sufficiently small (e.g., below a threshold of 0.80 to 1.0), the system adaptivity of the ink output is discontinued, such that the user's ink input is retained as written verbatim (e.g., without shrinking in size or line thickness as an adaptation by the system). This adaptive system capability is designed to correct for differences in users' writing when using a particular system, which prevent exceeding available system display space and also improve users' satisfaction with their handwriting appearance. An additional function of this adaptive processing is to create a smaller and finer ink display with affordances that encourage a user's subsequent writing to likewise be smaller and lighter. It will be appreciated that various thresholds and other types of dynamic adaptations may be used in other embodiments.

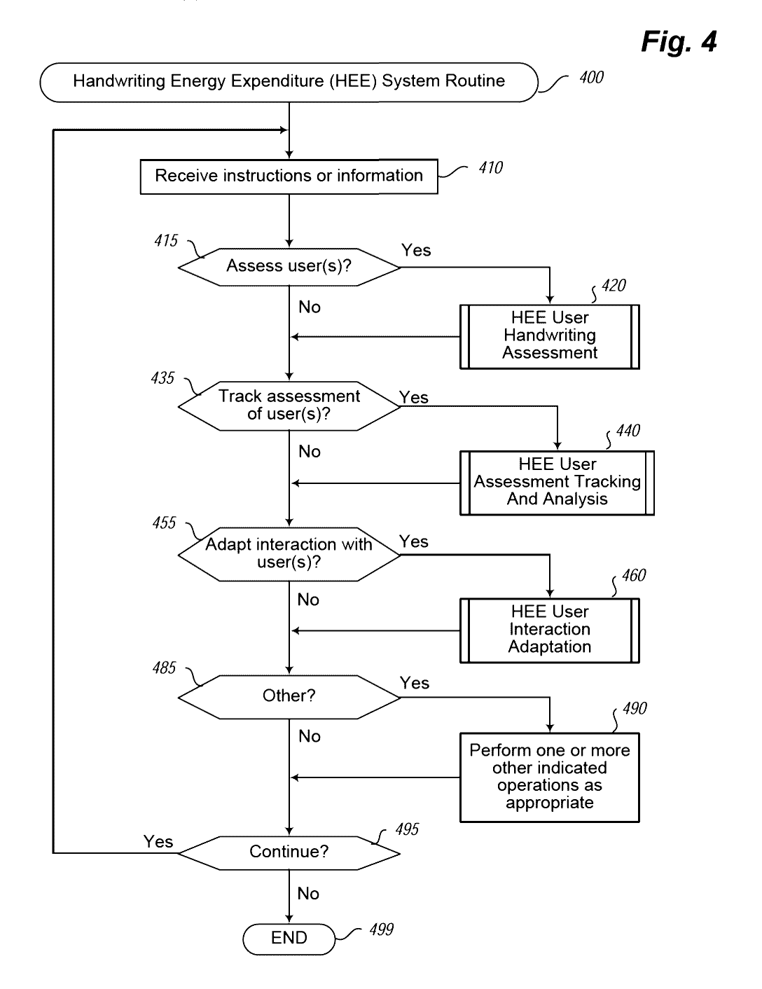

FIG. 4 illustrates a flow diagram of an example embodiment of a Handwriting Energy Expenditure (HEE) System routine 400. The routine may be performed by, for example, execution of the HEE System 140a and/or HEE System 140b of FIG. 1, and/or a system used to perform the techniques described with respect to one or more of FIG. 2A-3K. While the illustrated embodiment of the routine may assess and use handwritten input from different users (e.g., at different times, and/or simultaneously on different handwriting systems), in other situations an embodiment of the routine may execute on a client device specific to a particular user and interact only with the handwritten input of that user (or with the handwritten input of multiple users provided to that one device).

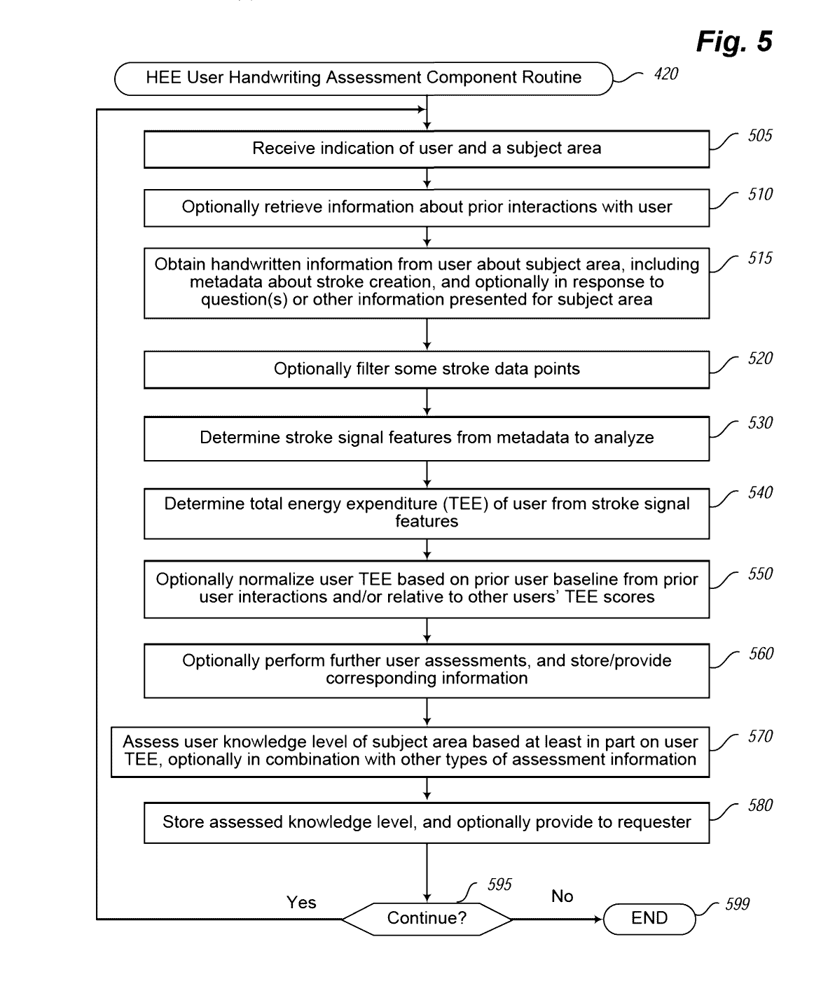

In the illustrated embodiment, the routine begins at block 410, where it receives information or instructions. The routine then continues to block 415 to determine whether information or instructions were received to initiate an assessment of one or more users, such as an explicit indication to perform such an assessment, or instead based on receiving handwritten input to be assessed for one or more such users (e.g., handwritten input that is being concurrently entered by a user, such as if the system is operating in a real time or near-real time manner). If it is determined to assess one or more such users, the routine continues to block 420 to initiate execution of an HEE User Handwriting Assessment component, with one example of such a component discussed in greater details with respect to FIG. 5. With respect to block 420, if multiple users are to be assessed, the illustrated embodiment of the routine invokes the indicated component separately for each user, although in other embodiments, a single indication may be used to supply information about multiple users to such a component, and the component may assess one or more such users as appropriate (whether sequentially, concurrently but separately, or in a combined manner).

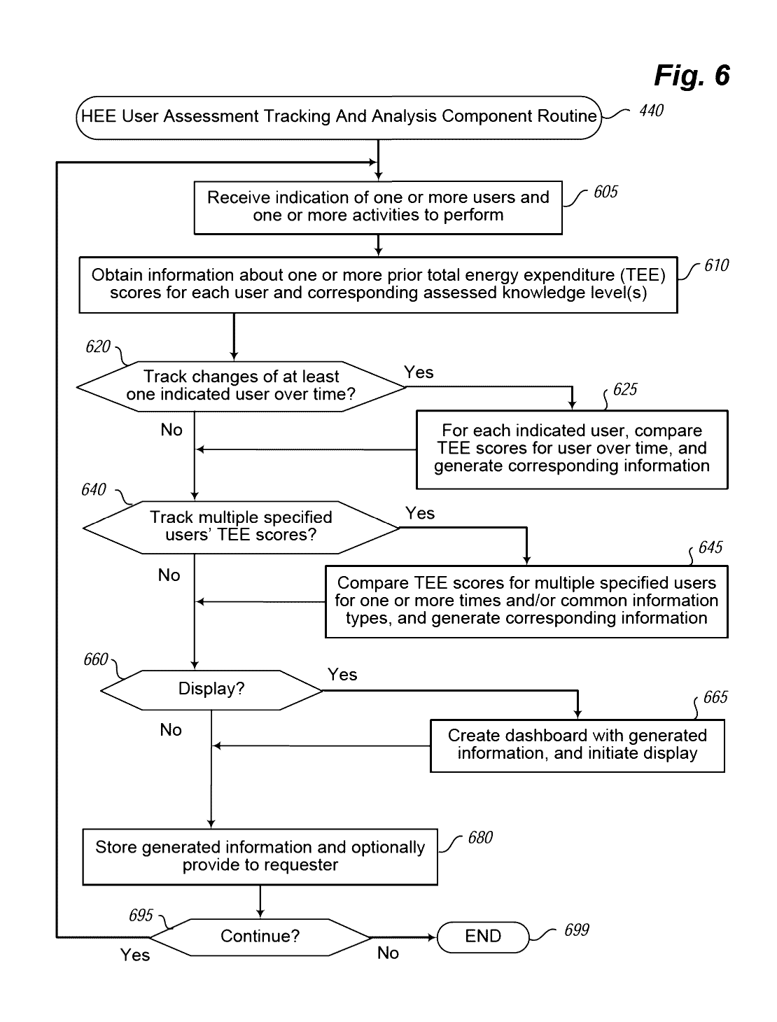

After block 420, or if it was instead determined in block 415 that the instructions or information received in block 410 are not to assess the handwritten input for one or more users, the routine continues instead to block 435 to determine whether the information or instructions received in block 410 indicate to track and optionally compare assessment information for one or more users, such as for one or more users whose information was just assessed with respect to block 420, or instead based on stored information from previous assessments of the one or more users. If it is determined to perform such tracking of the assessment information, the routine continues to block 440, where it executes an HEE User Assessment Tracking And Analysis component, with one example embodiment of such a component being discussed in greater detail with respect to FIG. 6.

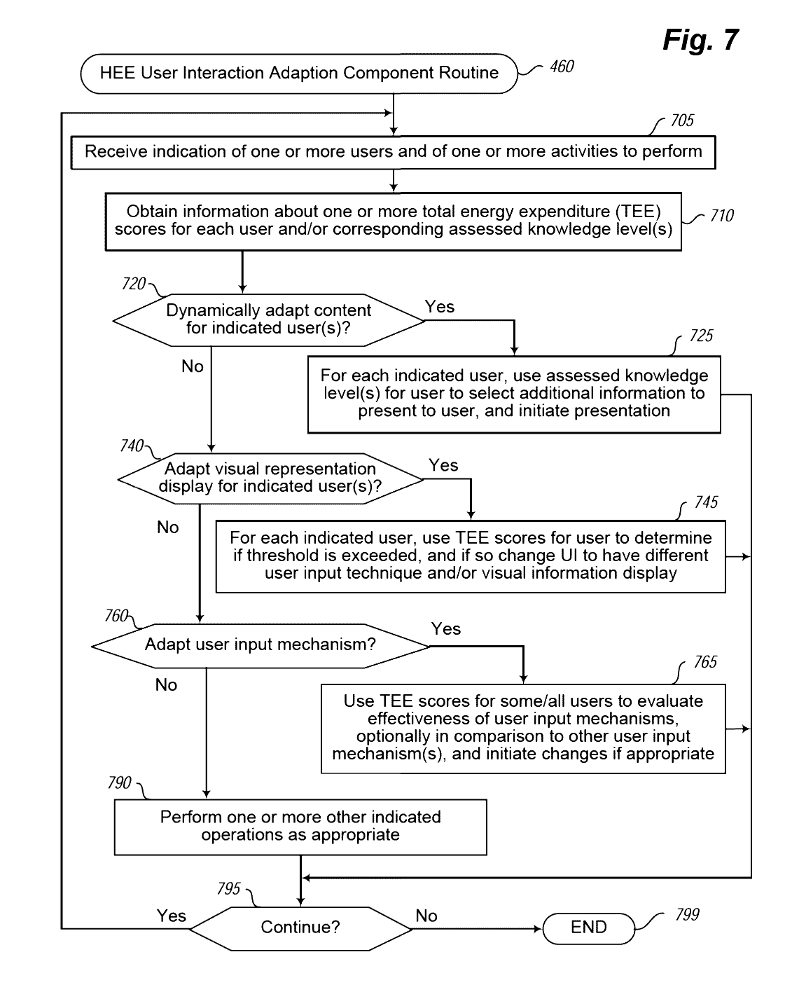

After block 440, or if it was instead determined in block 435 that the information or instructions received in block 410 were not to track user assessment, the routine continues instead to block 455 to determine whether the information or instructions received in block 455 indicate to perform an adaptation of further interactions with one or more users, such as in a dynamic manner (e.g., during a single interaction) with those users based on information received and used with respect to blocks 420 and/or 440, or instead to adapt future interactions at a later time. If it is determined to adapt such interactions, the routine continues to block 460 to perform HEE User Interaction Adaptation component, with one example embodiment of such a component being discussed in greater detail with respect to FIG. 7.

After block 460, or if it is instead determined in block 455 that the instructions or information received with respect to block 410 are not to adapt further interactions with one or more users, the routine continues to block 485 to determine whether one or more other operations to be performed are indicated from the information or instructions received with respect to block 410. If so, the routine continues to block 490 to perform one or more such other indicated operations as appropriate. As non-exclusive examples, such other indicated operations may include receiving and/or storing user-specific information for one or more users (e.g., baseline information about such users' total energy expenditure and/or information about one or more such users' assessed knowledge levels for one or more subject areas). In addition, other such indicated operations may include receiving information related to multiple users (e.g., for use in normalization activities), storing or presenting information about one or more subject areas (e.g., if the HEE System provides such information, rather than operating in conjunction with one or more other systems that provide such information), receiving and responding to requests for various generated and stored information (e.g., to generate corresponding displays), etc.

After block 490, or if it is instead determined in block 485 that the instructions or information received in block 410 do not indicate one or more other indicated operations, the routine continues to block 495 to determine whether to continue, such as until an explicit indication to terminate is received. If it is determined to continue, the routine returns to block 410 to await additional instructions or information, and otherwise continues to block 499 and ends.

FIG. 5 illustrates a flow diagram of an example embodiment of a HEE User Handwriting Assessment Component routine 420. The routine may be performed by, for example, execution of a corresponding component 142 of the HEE System 140a and/or 140b of FIG. 1, and may be invoked in various manners (e.g., with respect to block 420 of FIG. 4). In addition, while the illustrated embodiment of the routine 420 performs both a determination of total energy expenditure of a user from stroke signal features (with respect to block 540) and an assessment of the user's knowledge level of a subject area based at least in part on that information (in block 570), it will be appreciated that in other embodiments such a routine may perform only one of these activities, such as to determine and provide the total energy expenditure value for the user without performing a further assessment of the user knowledge level, or to instead receive information about a total energy expenditure of a user and proceed to perform an assessment of a user knowledge level without performing the determination of the total energy expenditure value.

In the illustrated embodiment, the routine 420 begins at block 505, where an indication is received of a user and a subject area. In block 510, information is optionally retrieved about prior interactions with the user, such as for a user-centered baseline or other normalization or comparison. In block 515, handwritten information is received or obtained for the user about the subject area, including information about one or more strokes and about metadata for those strokes involved in their creation, optionally in response to questions or other information that are first presented for the subject area (e.g., by the routine). It will be appreciated that the formation of the one or more strokes may occur over time, and in some cases the system will wait until a group of one or more strokes is completed, while in other embodiments will assess each stroke individually as it becomes available.

After block 515, the routine continues to block 520 to optionally filter one or more of the stroke-level data points, and in block 530 determines the stroke signal features from the corresponding metadata. Various stroke features may be used in different embodiments, as discussed in greater detail elsewhere herein. In block 540, the routine then determines the total energy expenditure of the user from the stroke signal features. As discussed in greater detail elsewhere herein, various formulas or other techniques for determining the total energy expenditure may be used in various embodiments.

After block 540, the routine continues to block 550 to optionally normalize the user's TEE value based on a prior user baseline from prior user interactions, and/or to normalize the user's TEE value based on other users' TEE values. While not illustrated here, the routine may further perform actions involved in determining the prior user baseline and/or obtaining and using the other users' TEE values for the normalization before they are used. In block 560, the routine then optionally performs further user assessments, stores corresponding information, and/or provides corresponding information to a requester. Such further user assessments may be performed with respect to information other than the stroke signal features of the handwritten input, such as to use information about the content of the handwritten input (e.g., accuracy of answers to questions), and/or other information that may reflect a user's knowledge level.

After block 560, the routine continues to block 570 to assess the user's knowledge level of the subject area based at least in part on the user's TEE score, optionally in combination with other types of assessment information as indicated with respect to block 560. As discussed in greater detail elsewhere herein, various techniques may be used for such a knowledge level assessment with respect to a total energy expenditure, such as to have multiple enumerated knowledge levels that are each associated with one or more corresponding total energy expenditures (e.g., a range of total energy expenditure values). In block 580, the routine then stores the assessed knowledge level and optionally provides to a requestor that invoked the routine. While not illustrated here, the routine may further perform other actions in some embodiments.

After block 580, the routine continues to block 595 to determine whether to continue, such as until an explicit indication to terminate is received. If it is determined to continue, the routine returns to block 505 to wait for a next indication of a user and a subject area, and otherwise continues to block 599 and ends.

FIG. 6 illustrates a flow diagram of an example embodiment of a HEE User Assessment Tracking And Analysis Component routine 440. The routine may be performed by, for example, execution of a corresponding component 142 of the HEE System 140a and/or 140b of FIG. 1, and may be invoked in various manners in various embodiments (e.g., with respect to block 440 of FIG. 4).

In the illustrated embodiment, the routine 440 begins at block 605, where an indication is received of one or more users and of one or more activities to be performed. The routine then continues to block 610 to obtain information about one or more prior total energy expenditure values for each user and about corresponding assessed knowledge levels, such as information previously determined by the HEE User Handwriting Assessment Component with respect to FIG. 5, although in other embodiments the routine may use only one of these types of information (e.g., only total energy expenditure, or only assessed knowledge level).

After block 610, the routine continues to block 620 to determine whether the instructions received are to track changes of at least one indicated user over time, and if so proceeds to block 625. In block 625, for each such indicated user, multiple TEE scores for the user over time are compared, and corresponding information is generated to assess the various scores, such as to reflect relative or absolute changes over time.

After block 625, or if it is instead determined in block 620 that changes of at least one indicated user over time are not being tracked, the routine continues to block 640 to determine whether the indication received is to track multiple specified users' TEE scores together, and if so continues to block 645. In block 645, TEE scores for the multiple specified users are compared to each other for each of one or more times and/or for one or more common types of information, and corresponding comparison information is generated, such as to indicate relative or absolute changes or differences between different users for a given time and/or information type.

After block 645, or if it is instead determined in block 640 not to track and compare multiple specified users' TEE scores, the routine continues to block 660 to determine whether to display specified information to one or more users, such as to a requester who invoked the routine to request a particular type of information. If so, the routine continues to block 665 to create a visual dashboard representation or other presentation that includes some or all of the generated information with respect to block 625 and/or 645 (e.g., in a manner similar to that discussed with respect to example FIGS. 3D and 3H), and initiates a corresponding display of that information on one or more computing systems. After block 665, or if it is instead determined in block 660 that the determination is not to currently display information, the routine continues instead to block 680 to store the information generated in block 625 and/or 645 and to optionally provide some or all of the generated information to a requestor. While not illustrated here, the routine may further perform other actions in some embodiments.

After block 680, the routine continues to block 695 to determine whether to continue, such as until an explicit indication to terminate is received. If it is determined to continue, the routine returns to block 605 to wait for an additional indication of one or more users and corresponding activities to perform, and otherwise continues to block 699 and ends.

FIG. 7 illustrates a flow diagram of an example embodiment of a HEE User Interaction Adaptation Component routine 460. The routine may be performed by, for example, execution of a corresponding component 142 of the HEE System 140a and/or 140b of FIG. 1, and may be invoked in various manners in various embodiments (e.g., with respect to block 460 of FIG. 4).

The illustrated embodiment of the routine 460 begins at block 705, where an indication is received of one or more users and of one or more corresponding activities. After block 705, the routine continues to block 710 to obtain information about one or more total energy expenditure scores for each user and/or about corresponding assessed knowledge levels for each user. While in some embodiments both TEE scores and assessed knowledge levels may be used, in other embodiments only one of the indicated types of information may be used for the user interaction and adaptation, as discussed in greater detail elsewhere herein.

After block 710, the routine continues to block 720 to determine whether the one or more indicated activities include dynamically adapting content being provided for display to one or more indicated users, and if so continues to block 725. In block 725, for each such indicated user, the assessed knowledge level for the user is used to select additional information to present to the user, such as part of dynamic adaptation of content, and presentation of the selected additional information is initiated.

If it is instead determined in block 720 that the one or more activities do not include dynamically adapting content for one or more indicated users, the routine continues instead to block 740 to determine whether the one or more indicated activities include adapting the user interface and/or displayed information for one or more indicated users. If so, the routine continues to block 745 to, for each such indicated user, use one or more TEE scores for the user to determine if a threshold is exceeded, and if so to change the UI and/or other visual representation of the displayed information (e.g., of the handwritten input) for some or all users.

If it is instead determined in block 740 that the indicated activities do not include adapting the user interface or displayed information for one or more indicated users, the routine continues instead to block 760 to determine whether the one or more indicated activities include adapting a user input mechanism and/or hardware system for further use, and if so continues to block 765, such as for use in usability testing. If so, in block 765 the routine uses the TEE scores for some or all indicated users to evaluate the effectiveness of the user input mechanism and/or hardware system for one or more periods of time, optionally in comparison to other user input mechanisms and/or hardware systems, and generates corresponding information, such as to initiate changes to one or more subsystems if appropriate.

If it is instead determined in block 760 that the one or more indicated activities do not include adapting the user input mechanisms or other hardware systems, the routine continues to block 790 to perform one or more other indicated operations as appropriate, such as to store information that was generated or to otherwise provide information for use in making later determinations.

After blocks 725, 745, 765 or 790, the routine continues to block 795 to determine whether to continue, such as until an explicit indication to terminate is received. If it is determined to continue, the routine returns to block 705 to wait for one or more additional indications of users and activities, and otherwise continues to block 799 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. It will similarly be appreciated that the data structures discussed above may be structured in different manners, including for databases or user interface screens/pages or other types of data structures, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

Additional details are included below regarding non-exclusive illustrative examples of using the described techniques. In addition, the following term descriptions may be used with respect to at least some of these illustrative examples discussed below.

Domain expertise refers to subject-matter expertise, or knowledge about a particular content domain (e.g., algebra, geometry, genetics), as may be evident in the person's percentage of correct problem-solving performance. A domain expert would typically have a higher percentage of correct problem-solving performance, compared with a non-expert. Domain expertise is a relatively stable state of subject-matter knowledge, although it can shift gradually over a period of weeks or months when a person is learning new subject matter.

Dynamic handwriting characteristics refers to features in a person's handwriting that reflect how it was formed over time (e.g., moment-by-moment pressure applied).

Pen system timestamp refers to a pen system's record of time when certain events occurred (e.g., pen down event).

Pen system location coordinates refers to a pen system's record of where in an x,y coordinate space the pen tip was located while writing.

Pen system pressure refers to the ability of a pen system to record data about the force applied by the user's pen tip when writing on a surface, as well as the number of pressure levels that can be detected (i.e., sensitivity).

Average pen stroke distance refers to the mean distance of individual pen strokes from pen down to pen up.

Average pen stroke pressure refers to the mean pressure or force applied by a user when writing individual pen strokes from pen down to pen up.

Average pen stroke duration refers to the mean duration of individual pen strokes from pen down to pen up.

Stroke signal features refer to features (e.g., pressure, distance, duration) of a single handwritten stroke.

Writing efficiency refers to how efficiently the act of writing is performed in terms of conserving resources like time, for example how quickly a letter is formed. This contrasts with metrics of total effort and energy expended by a user.

Disfluencies refer to interruptions to the smooth flow of a person's communication within a modality, for example pausing or making content corrections when writing.

User-centered baseline refers to an individual's average personal values for specific data being processed, for example the typical size and other features of their writing relative to the larger population.

In some embodiments, the described techniques are used for estimating a person's level of domain expertise based on total energy expended while writing on a computer with finger input, a digital pen, or similar input device. The described techniques are based on dynamic signal information collected from the computer system, and can be computed automatically. This can be used to: (1) provide an analytics tool to assess and summarize domain expertise automatically while using a computer system that accepts pen or finger input. For example, it could be used to track and assess domain expertise in students during education in order to assess their learning progress automatically when using a computer system, without the need to explicitly take tests. This assessment information could be summarized and displayed automatically in simplified form to a teacher, for example on a digital dashboard, so he or she is able to intervene by providing a student with instructional assistance. As another example, this could be used to assess domain expertise in adult job candidates who are applying for work that requires specific technical expertise. In addition, the same assessment information could be used to (2) adapt the curriculum content or problem difficulty presented by an educational system, so that it is more appropriately tailored for an individual student's level of competence.

An additional use of these techniques is to automatically assess and improve a computer system's usability, and/or the quality of users' experience in using such a hardware system. A more usable pen system is one that supports users' ability to precisely control the construction of well-formed representations, such as letters, numbers, symbols, and diagrams, without expending more energy than necessary. This includes supporting users' ability to write representations composed of strokes that are shorter in length, briefer in duration, and involve applying lighter pressure, without experiencing adverse consequences such as system feedback delays, skipped ink, and so forth. One metric for evaluating computer usability is the extent to which the system supports users' precise control over forming handwritten representations, while also reducing the total signal-level writing energy they expend. If a user expends excess energy while using a computer system over time, then this increases the likelihood of fatigue and repetitive stress syndrome. To support the above aims, the described techniques can be used to (3) automatically assess and display a log summary of a particular system's usability, and (4) automatically adapt system processing to promote improved usability.

The described techniques can thus be used to automatically predict a person's level of domain expertise based on signal-level features of dynamic writing, without requiring any analysis of the content that was written. Prediction may be based on the global adaptation of one or more signal-level writing features, which change during a person's consolidation of domain expertise. Previous learning analytic techniques have not been used to automatically predict a person's level of domain expertise, a mental state, utilizing signal-level features in dynamic handwriting or ink-based data, without the need for any content analysis. Furthermore, the techniques described herein are broadly applicable, as they are based on principles involving change in the total writing energy expended.

The total energy that a person expends during writing can be estimated reliably based on signal-level features, such as a finger or written pen stroke's average distance, pressure, and duration. Lower total energy expended during writing (i.e., shorter distance, lighter pressure, briefer duration of written strokes) is a significant predictor of higher levels of domain expertise. That is, there is an inverse relation between total signal-level energy expended during writing and a person's level of expertise in the domain about which they are communicating. As a person progresses from being a novice to expert in a domain, they adapt the total signal-level energy expended during writing to conserve it, which provides an index of their level of expertise in that domain.

Modeling of total writing energy expended can be calculated as a summary formula for a given person at a particular point in time while writing domain-specific content. It may combine three signal features (i.e., average stroke distance (ADis), average stroke pressure (APre), and average stroke duration (ADur)), or a subset of them (e.g., distance and pressure), and it also may combine these features with additional ones. The specific estimation process for calculating total energy using these features also may vary. For example, written pressure may be calculated as a statistical average over all points in a stroke, or as a 3-point maximum pressure average within a stroke. In one example embodiment, total writing energy expended (TE) can be estimated as the average pressure applied across the average total stroke distance, or the product of average total stroke pressure and distance: TE=APre×ADis. In another example embodiment, total writing energy expended (TE) can be estimated by normalizing the average scores for each type of signal feature (i.e., creating z-scores), weighting each feature by the magnitude of its known statistical effect size (ES) in predicting expertise, or R² which is the statistical percentage of variance accounted for by a signal feature, and then combining this feature information additively: TE=(ES ADis×ADis)+(ES APre×APre)+(ES ADur×ADur). Various other techniques for using one or more stroke signal features to determine, predict and/or estimate a user's total energy expenditure in producing handwritten input may also be used, some of which are enumerated herein.

A series of data processing steps that can be used to extract the TE summary metric in an output file in one embodiment includes (1) sampling handwriting data over time from the same person while using a digital system to solve domain-specific problems; (2) summarizing written data as individual strokes from pen down to pen up on the surface, which may involve filtering out strokes with too few points or other preprocessing; (3) extracting location coordinates, pressure, and time stamps from data created by the pen or fingertip while writing on a surface, based on an API provided by the computer vendor for auto-logging the relevant signal features in users' written data; (4) calculating distance, pressure, and duration of individual strokes, and average stroke distance (ADis), pressure (APre), and duration (ADur) of the strokes over accumulated data; (5) computing total signal-level energy expended during writing as a composite score (TE); and (6) normalizing this score for each individual with a user-centered baseline of their writing in a domain for which they are novice. This user-centered baseline would be recalculated under some circumstances to ensure accuracy, for example when the user shifts to a new pen system.

Models of total energy expended during writing may be different from estimating writing efficiency (e.g., speed of writing, or stroke distance divided by duration), or total writing energy expended per unit of time (e.g., stroke distance×pressure, divided by duration), and so forth. The models and corresponding described techniques discussed herein involve total energy expended during writing, because effortful activity is a causal factor in determining acquisition of domain expertise, not how efficiently an action is performed.

The models of total writing energy expended that are described herein may or may not combine any additional factors in the prediction of domain expertise, including ones involving writing efficiency or energy expended per unit of time. They may add factors that reflect total writing energy expended at different levels of analysis, such as the lexical or dialogue level (e.g., total number of words written per concept, average length of noun phrase descriptions). They may also add factors that reflect the fluency of communication (e.g., number and duration of pauses when writing, percentage of written disfluencies per total representations). Additional factors may involve information at different levels of analysis or in other modalities, such as speech (e.g., speech amplitude, speech duration), physical movement or gaze patterns, touch or typing. Additional factors also may involve physiological or neurological indices of total energy expended (e.g., pen grip force, EMG frequencies in hand or arm muscles during writing, degree of brain activation). The above examples illustrate other information sources that may be added to the model, but possible additions are not limited to these examples.

The described techniques are intended for use by, but not limited to, student learners in educational contexts. Each user may have and use a digital pen or similar input device with a unique identifier, and would engage in writing. The described techniques can be applied to literate users, who have established handwriting skills and adequate motor control of their writing. It can be applied to either children or adults, and to either disabled or non-disabled individuals provided they have the basic abilities outlined above. In addition, the described techniques can be applied to native communicators of any world language that has a written script. It also can be applied while users are working individually, or while collaborating with others in a group. The described techniques can be applied to different content domains.

Application of the described techniques may involve sampling handwriting data over time from the same person while they use a computer system to work on solving domain-specific problems. Data involving spuriously brief strokes of less than a minimum number of points may be filtered out, and other data filtering or preprocessing may or may not be applied. For example, recognition software may be used to filter out off-task written content before calculating TE averages involving the extracted signal features that are computed over the accumulated data. The described techniques discussed above can be applied using real-time computational techniques or, alternatively, at specific points in time with batch processing of the relevant signal information after a delay.

The described techniques discussed above may be realized using different engineering or statistical techniques. In particular, it can involve calculation of the relevant signal information using an explicit formula for summarizing the total signal-level energy expended by a person while writing. It also can involve supervised or unsupervised processing using machine learning techniques. Examples of machine learning techniques that may be applied include, but are not limited to, the use of Support Vector Machine (SVM), Random Forest (RF), and Naïve Bayes (NB) classifiers for predicting which students are novices versus experts in a given domain. These and similar machine learning classification algorithms may be used to conduct basic two-class classification of experts versus non-experts, or more complex multi-level classification predictions. If supervised processing, this may be based on the relevant set of signal features, and the directionality and relative magnitude of their adaptation in domain novices versus experts, as discussed elsewhere herein. In addition, more than one machine learning technique may be deployed at a time, either to combine their prediction output or to select the best performing technique. The described techniques discussed also may combine machine-learning algorithms with statistical models involving explicit formulas. These latter examples represent a hybrid processing approach.

The above processes may or may not process all available written data, versus sampling data of a specific type. For example, analyses may be conducted exclusively based on specific types of representation (e.g., symbols), during specific problem difficulty levels (e.g., moderate difficulty), or other selective data characteristics that may improve prediction within a given domain. As an additional example, sensor-based contextual information on a device may be used to discontinue data sampling when a user is moving, thereby filtering out noisy writing samples.

The described techniques apply to automatically predicting a person's level of “domain expertise,” “subject-matter expertise (SME),” or knowledge about a particular content domain (e.g., algebra, geometry, genetics), as would be evident in the person's percentage of correct problem-solving performance. The described techniques can distinguish domain experts (e.g., who habitually have a higher percentage of correct problem-solving performance) from non-experts (e.g., who habitually have a lower percentage of correct problem-solving performance) automatically under circumstances in which people are completing problem-solving tasks of comparable difficulty within a given domain while working in the same setting. Domain expertise is a relatively stable state of subject-matter knowledge, although it can shift gradually (e.g., over a period of weeks or months) when a person is learning new subject matter. In this regard, domain expertise contrasts with the transient level of cognitive load that is experienced by a person when working on a particular problem. Cognitive load fluctuates on a momentary basis, and can be low one moment and high the next.

The described techniques apply to any computer system that includes input involving a pen, stylus, finger, wearable tip on a finger or fingernail, or similar device as an input tool that is capable of extracting relevant signal features (e.g., x,y location coordinates, pressure, time stamps) of points created by the input tip during writing. Such systems may write on any surface, including but not limited to paper, computer screens, electronic whiteboards or tables, cell phones, wearable computer devices such as watches, in-vehicle steering wheels or other input surfaces, and other materials that may or may not be digital in nature. Such systems typically would involve a visible trace of users' input, but this trace may not be durable over time or it may not be present at all.

Non-exclusive example embodiments described herein are further described in the following clauses.

A. A computer-implemented method comprising:

receiving, by a configured computing device, handwritten information by a user;

determining, by the configured computing device and based at least in part on one or more stroke signal features of the handwritten information, a total amount of energy expenditure by the user in generating the handwritten information; and

using, by the configured computing device, information about the determined total amount of energy expenditure to perform further user interactions.

B. The computer-implemented method of clause A wherein the received handwritten information is related to a specified subject area, wherein the one or more stroke signal features include multiple stroke signal features on which the determining is based, and wherein the method further comprises:

assessing, by the configured computing device and based at least in part on the determined total amount of energy expenditure, a level of knowledge of the user for the specified subject area; and

presenting, by the configured computing device and to the user, additional information related to the specified subject area that is selected based at least in part on the assessed level of knowledge of the user.

C. The computer-implemented method of clause B further comprising measuring, by the configured computing device, the multiple stroke signal features of the handwritten information, including one or more of stroke pressure, stroke distance or stroke duration.

D. The computer-implemented method of clause B wherein the multiple stroke signal features of the handwritten information include at least stroke pressure, stroke distance and stroke duration, wherein the determining of the total amount of energy expenditure by the user includes combining information about the multiple stroke signal features, and wherein the assessing of the level of knowledge of the user is performed without using any information other than the determined total amount of energy expenditure.

E. The computer-implemented method of clause B wherein the determining of the total amount of energy expenditure by the user includes retrieving information about a predefined technique for using information about the multiple stroke signal features, and combining information about the multiple stroke signal features using the predefined technique.

F. The computer-implemented method of clause B further comprising using one or more machine learning techniques to identify a defined technique for using information about the multiple stroke signal features, and wherein the determining of the total amount of energy expenditure by the user includes combining information about the multiple stroke signal features using the defined technique.

G. The computer-implemented method of clause B wherein the receiving of the handwritten information by the user includes receiving data for one or more strokes that each has a series of points with associated information including at least location information and timing information, and wherein the determining of the total amount of energy expenditure by the user includes generating, for each of one or more of location or timing, a statistical average over at least some of the series of points for each of the one or more strokes.

H. The computer-implemented method of clause B wherein the receiving of the handwritten information by the user includes receiving data for one or more strokes that each has a series of points with associated information including at least pressure information, and wherein the determining of the total amount of energy expenditure by the user includes generating, for each of the one or more strokes, a statistical average of pressure over at least some of the series of points for the stroke.

I. The computer-implemented method of clause B wherein the determining of the total amount of energy expenditure by the user includes identifying a baseline amount of energy expenditure by the user in one or more prior handwritten inputs, and using the baseline amount of energy expenditure by the user as part of determining a difference from the baseline amount for the received handwritten information.

J. The computer-implemented method of clause B further comprising:

determining, by the configured computing device, a change in the assessed level of knowledge of the user with respect to one or more previous assessed levels of knowledge of the user for the specified subject area; and

initiating, by the configured computing device, a visual display that includes at least information about the determined change in the assessed level of knowledge of the user.

K. The computer-implemented method of clause B wherein the receiving of the handwritten information by a user includes using a touch-sensitive area of the computing device to receive information from at least one of a finger of the user, a device held by the user, or a device attached to the user.

L. The computer-implemented method of clause B wherein the receiving of the handwritten information by a user includes receiving information from a digital pen held by the user during the generating of the handwritten information.

M. The computer-implemented method of clause B wherein the receiving of the handwritten information by the user includes receiving data for strokes that each has a series of points with associated information including at least location information and timing information, wherein the method further comprises determining to exclude information for at least one of the strokes based at least in part on one or more characteristics involved in generation of the at least one stroke, and wherein the determining of the total amount of energy expenditure is performed for one or more strokes that do not include the at least one stroke.

N. The computer-implemented method of clause B wherein the presenting of the additional information occurs dynamically during a single interaction session with the user that also includes the receiving of the handwritten information, and further includes selecting the additional information based at least in part on the additional information being associated with the assessed level of knowledge of the user.

O. The computer-implemented method of clause N wherein the selecting of the additional information is performed as part of at least one of adapting a level of reading information for the user to the assessed level of knowledge of the user, or performing dynamically adapted testing of the user

P. A system, comprising:

one or more hardware processors of one or more computer systems; and

a handwriting energy expenditure system that, when executed by at least one of the one or more hardware processors, causes the at least one hardware processor to assess handwritten input, including:
receiving, for each of a plurality of users, handwritten information by the user;
determining, for each of the plurality of users, one or more stroke signal features of the handwritten information by the user;
determining, for each of the plurality of users, and based at least in part on the determined stroke signal features of the handwritten information by the user, a total amount of energy expenditure by the user;
aggregating, for multiple users of the plurality, the determined total amounts of energy expenditure of the multiple users; and
providing information about the aggregated determined total amounts of energy expenditure for the multiple users.

Q. The system of clause P wherein the handwritten information received for each of the plurality of users is related to a specified subject area, and wherein the handwriting energy expenditure system includes software instructions that, when executed, further cause the at least one hardware processor to assess, for each of the multiple users and based at least in part on the determined total amount of energy expenditure for the user, a level of knowledge of the user for the specified subject area, and to provide information about the assessed levels of knowledge for the multiple users.

R. The system of clause Q wherein the multiple users are students learning the specified subject area, and wherein the providing of the information about the assessed levels of knowledge for the multiple users includes providing the information to a teacher of the multiple users.

S. The system of clause R wherein the providing of the information to the teacher includes generating a visual display that has information for the multiple users including at least the assessed levels of knowledge for the multiple users.

T. The system of clause Q wherein the multiple users are applicants for a job involving the specified subject area, and wherein the providing of the information about the assessed levels of knowledge for the multiple users includes providing the information to an entity involved in hiring for the job.

U. The system of clause P wherein the handwriting energy expenditure system includes software instructions that, when executed, further cause the at least one hardware processor to compare, for each of the multiple users, the determined total amount of energy expenditure for the user to total amounts of energy expenditure for other users of the plurality, and to normalize the determined total amount of energy expenditure for each of the multiple users based at least in part on the comparing, and wherein the assessing of the determined total amount of energy expenditure for each of the multiple users is further based on the normalized determined total amount of energy expenditure for the user.

V. The system of clause P wherein the assessing of the determined total amount of energy expenditure for one of the multiple users includes combining the determined total amount of energy expenditure for the one user with additional information about accuracy of the handwritten information by the one user.

W. The system of clause P wherein the assessing of the determined total amount of energy expenditure for one of the multiple users includes combining the determined total amount of energy expenditure for the one user with additional information about lexical terms used in the handwritten information by the one user.

X. The system of clause P wherein the assessing of the determined total amount of energy expenditure for one of the multiple users includes combining the determined total amount of energy expenditure for the one user with additional information about writing efficiency by the one user in producing the handwritten information by the one user.

Y. The system of clause P wherein the handwritten information received from the multiple users is provided using one or more types of devices involved in an evaluation for usability, and wherein the providing of the information about the aggregated determined total amounts of energy expenditure for the multiple users includes providing the information as part of the evaluation to an entity involved in the evaluation.

Z. The system of clause P wherein the receiving of the handwritten information from the multiple users occurs via a graphical user interface displayed on each of one or more computing devices, and wherein the assessing of the handwritten input further includes:

determining, based at least in part on the determined total amounts of energy expenditure for the multiple users, to modify the graphical user interface in a determined manner to reduce energy expended while providing future handwritten input, the modifying in the determined manner including changing a portion of the graphical user interface that is used for receiving the future handwritten input;

modifying the graphical user interface in the determined manner; and

receiving additional handwritten input from one or more of the multiple users in the modified graphical user interface.

AA. The system of clause P wherein the receiving of the handwritten information from the multiple users includes displaying visual representations of the handwritten information on one or more computing devices, and wherein the assessing of the handwritten input further includes:

determining, based at least in part on the determined total amounts of energy expenditure for the multiple users, to modify a visual representation of future handwritten input displayed on the one or more computing devices, the modifying including changing a size of the visual representation of the future handwritten input to reduce energy expended while providing the future handwritten input; and

displaying, after receiving the future handwritten input, the future handwritten input on the one or more computing devices using the modified visual representation.

BB. The system of clause P wherein the determining of the one or more stroke signal features of the handwritten information for each of the multiple users includes determining multiple stroke signal features of the handwritten information for each of the multiple users, the multiple stroke signal features including a plurality of stroke pressure, stroke distance or stroke duration, and wherein the determining of the total amount of energy expenditure by each of the multiple users includes combining information about the determined multiple stroke signal features of the handwritten information for each of the multiple users without using any other information.

CC. The system of clause P wherein the one or more computer systems include multiple client computing devices being used by the multiple users, and wherein each of the client computing devices includes a touch-sensitive area on which handwritten input is received and a display on which visual representations of the received handwritten input is shown.

DD. The system of clause P wherein the one or more computer systems include a server system that receives information over one or more computer networks from multiple devices being used by the multiple users to provide handwritten input.

EE. The system of clause P wherein the providing of the information about the aggregated determined total amounts of energy expenditure for the multiple users includes generating a visual display that has information for the multiple users including at least the determined total amounts of energy expenditure for the multiple users.

FF. The system of clause P wherein the handwriting energy expenditure system consists of one or more means for performing the assessing of the handwritten input.

GG. A non-transitory computer-readable medium having stored contents that cause a computing device to perform a method, the method comprising:

receiving, by a computing device and from a user, handwritten information related to a specified subject area;

determining, by the computing device and based at least in part on one or more stroke signal features of the handwritten information, a total amount of energy expenditure by the user in generating the handwritten information;

assessing, by the computing device, based on the determined total amount of energy expenditure and without using any content of the handwritten information, a level of knowledge of the user for the specified subject area, including comparing the determined total amount of energy expenditure for the user to one or more other amounts of previously determined energy expenditure from providing other handwritten information; and

providing, by the computing device, information about the assessed level of knowledge of the user.

HH. The non-transitory computer-readable medium of clause GG wherein the one or more stroke signal features include multiple stroke signal features that include a plurality of stroke pressure, stroke duration or stroke distance, and wherein the stored contents include software instructions that, when executed, further cause the computing device to:

before the receiving of the handwritten information, display information to the user; and

after the assessing of the level of knowledge of the user, dynamically modify a further display of information to the user based at least in part on the assessed level of knowledge.

The non-transitory computer-readable medium of clause HH wherein the computing device includes a touch-sensitive input area on which the handwritten information is received from the user, and includes a display on which the displaying of the information to the user and the further display of information to the user occur.

JJ. A computer-implemented method comprising:

presenting, to a user of a configured computing device and on a display screen of the configured computing device, initial information that includes one or more questions related to a specified subject area;

receiving, by the configured computing device, responses to the one or more questions that are handwritten by the user on a touch-sensitive input area of the configured computing device;

determining, by the configured computing device, multiple stroke signal features of the handwritten responses that include stroke pressure and stroke distance;

determining, by the configured computing device and based at least in part on the determined multiple stroke signal features, a total amount of energy expended by the user in creating the handwritten responses;

assessing, by the configured computing device and based at least in part on the determined total amount of energy expended, one of multiple levels of knowledge of the user for the specified subject area, wherein the assessing is performed without using information about accuracy of the handwritten responses and is based at least in part on a comparison to other amounts of energy expended by a plurality of other users in providing other handwritten responses to the one or more questions;

determining, by the configured computing device and based at least in part on the assessed level of knowledge of the user for the specified subject area, to alter additional information presented to the user for the specified subject area; and

presenting, by the configured computing device and to the user on the display screen, the altered additional information related to the specified subject area.

KK. The computer-implemented method of clause JJ wherein the assessing of the level of knowledge of the user for the specified subject area is performed using only the determined total amount of energy expended, and wherein the determining to alter the additional information presented to the user for the specified subject area is performed dynamically during a single interaction session with the user and includes selecting the additional information based at least in part on the additional information being associated with the assessed level of knowledge of the user.

LL. The computer-implemented method of clause JJ further comprising:

determining, by the configured computing device and in response to the determined total amount of energy expended, to modify a graphical user interface displayed on the display screen of the configured computing device in a determined manner to reduce energy expended by the user while providing future handwritten input, the modifying in the determined manner including changing a portion of the graphical user interface that is used for receiving the future handwritten input;

modifying, by the configured computing device and dynamically during a single interaction session with the user, the graphical user interface in the determined manner; and

receiving, by the configured computing device and during the single interaction session with the user, additional handwritten input from the user in the modified graphical user interface.

MM. The computer-implemented method of clause JJ further comprising:

determining, by the configured computing device and in response to the determined total amount of energy expended, to modify a visual representation of future handwritten input that is displayed on the display screen of the configured computing device, the modifying of the visual representation including changing a size of the visual representation of the future handwritten input to reduce energy expended by the user while providing the future handwritten input;

receiving, by the configured computing device and dynamically during a single interaction session with the user, additional handwritten input from the user; and

displaying, by the configured computing device, the additional handwritten input using the modified visual representation.

It will also be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A computer-implemented method comprising:
presenting, to a user of a configured computing device and on a display screen of the configured computing device, initial information that includes one or more questions related to a specified subject area;
receiving, by the configured computing device, responses to the one or more questions that are handwritten by the user on a touch-sensitive input area of the configured computing device;
determining, by the configured computing device, multiple stroke signal features of the handwritten responses that include stroke pressure and stroke distance;
determining, by the configured computing device and based at least in part on the determined multiple stroke signal features, a total amount of energy expended by the user in creating the handwritten responses;
assessing, by the configured computing device and based at least in part on the determined total amount of energy expended, one of multiple levels of knowledge of the user for the specified subject area, wherein the assessing is performed without using information about accuracy of the handwritten responses and is based at least in part on a comparison to other amounts of energy expended by a plurality of other users in providing other handwritten responses to the one or more questions;
determining, by the configured computing device and based at least in part on the assessed level of knowledge of the user for the specified subject area, to alter additional information presented to the user for the specified subject area; and
presenting, by the configured computing device and to the user on the display screen, the altered additional information related to the specified subject area.

2. The computer-implemented method of claim 1 wherein the assessing of the level of knowledge of the user for the specified subject area is performed using only the determined total amount of energy expended, and wherein the determining to alter the additional information presented to the user for the specified subject area is performed dynamically during a single interaction session with the user and includes selecting the additional information based at least in part on the additional information being associated with the assessed level of knowledge of the user.

3. The computer-implemented method of claim 1 further comprising:
determining, by the configured computing device and in response to the determined total amount of energy expended, to modify a graphical user interface displayed on the display screen of the configured computing device in a determined manner to reduce energy expended by the user while providing future handwritten input, the modifying in the determined manner including changing a portion of the graphical user interface that is used for receiving the future handwritten input;
modifying, by the configured computing device and dynamically during a single interaction session with the user, the graphical user interface in the determined manner; and
receiving, by the configured computing device and during the single interaction session with the user, additional handwritten input from the user in the modified graphical user interface.

4. The computer-implemented method of claim 1 further comprising:
determining, by the configured computing device and in response to the determined total amount of energy expended, to modify a visual representation of future handwritten input that is displayed on the display screen of the configured computing device, the modifying of the visual representation including changing a size of the visual representation of the future handwritten input to reduce energy expended by the user while providing the future handwritten input;
receiving, by the configured computing device and dynamically during a single interaction session with the user, additional handwritten input from the user; and
displaying, by the configured computing device, the additional handwritten input using the modified visual representation.

5. A computer-implemented method comprising:
receiving, by a configured computing device, handwritten information by a user related to a specified subject area;
determining, by the configured computing device and based at least in part on multiple stroke signal features of the handwritten information, a total amount of energy expenditure by the user in generating the handwritten information;
assessing, by the configured computing device and based at least in part on the determined total amount of energy expenditure, a level of knowledge of the user for the specified subject area; and
presenting, by the configured computing device and to the user, additional information related to the specified subject area that is selected based at least in part on the assessed level of knowledge of the user.

6. The computer-implemented method of claim 5 further comprising measuring, by the configured computing device, the multiple stroke signal features of the handwritten information, including one or more of stroke pressure, stroke distance or stroke duration.

7. The computer-implemented method of claim 5 wherein the multiple stroke signal features of the handwritten information include at least stroke pressure, stroke distance and stroke duration, wherein the determining of the total amount of energy expenditure by the user includes combining information about the multiple stroke signal features, and wherein the assessing of the level of knowledge of the user is performed without using any information other than the determined total amount of energy expenditure.

8. The computer-implemented method of claim 5 wherein the determining of the total amount of energy expenditure by the user includes determining a technique for assessing information about the multiple stroke signal features, and combining information about the multiple stroke signal features using the determined technique, wherein the determining of the technique includes one of retrieving information about a predefined technique or of using one or more machine learning techniques to dynamically identify the technique.

9. The computer-implemented method of claim 5 wherein the receiving of the handwritten information by the user includes receiving data for one or more strokes that each has a series of points with associated information including at least location information and timing information and pressure information, and wherein the determining of the total amount of energy expenditure by the user includes generating, for each of one or more of location or timing or pressure, a statistical average over at least some of the series of points for each of the one or more strokes.

10. The computer-implemented method of claim 5 wherein the determining of the total amount of energy expenditure by the user includes identifying a baseline amount of energy expenditure by the user in one or more prior handwritten inputs, and using the baseline amount of energy expenditure by the user as part of determining a difference from the baseline amount for the received handwritten information.

11. The computer-implemented method of claim 5 further comprising:
determining, by the configured computing device, a change in the assessed level of knowledge of the user with respect to one or more previous assessed levels of knowledge of the user for the specified subject area; and
initiating, by the configured computing device, output that includes at least information about the determined change in the assessed level of knowledge of the user.

12. The computer-implemented method of claim 5 wherein the receiving of the handwritten information by a user includes at least one of receiving information from a digital pen held by the user during the generating of the handwritten information or of using a touch-sensitive area of the computing device to receive information from at least one of a finger of the user, a device held by the user, or a device attached to the user.

13. The computer-implemented method of claim 5 wherein the receiving of the handwritten information by the user includes receiving data for strokes that each has a series of points with associated information including at least location information and timing information, wherein the method further comprises determining to exclude information for at least one of the strokes based at least in part on one or more characteristics involved in generation of the at least one stroke, and wherein the determining of the total amount of energy expenditure is performed for one or more strokes that do not include the at least one stroke.

14. The computer-implemented method of claim 5 wherein the presenting of the additional information occurs dynamically during a single interaction session with the user that also includes the receiving of the handwritten information, and further includes selecting the additional information based at least in part on the additional information being associated with the assessed level of knowledge of the user, the selecting of the additional information being performed as part of at least one of adapting a level of reading information for the user to the assessed level of knowledge of the user, or performing dynamically adapted testing of the user

15. A system, comprising:
one or more hardware processors of one or more computer systems; and
a handwriting energy expenditure system that, when executed by at least one of the one or more hardware processors, causes the at least one hardware processor to assess handwritten input, including:
receiving, for each of multiple users, handwritten information by the user;
determining, for each of the multiple users, one or more stroke signal features of the handwritten information by the user;
determining, for each of the multiple users, and based at least in part on the determined stroke signal features of the handwritten information by the user, a total amount of energy expenditure by the user; and
providing information about the determined total amounts of energy expenditure for one or more users of the plurality of users.

16. The system of claim 15 wherein the handwritten information received for each of the multiple users is related to a specified subject area, wherein the handwriting energy expenditure system includes software instructions that, when executed, further cause the at least one hardware processor to assess, for each of the multiple users and based at least in part on the determined total amount of energy expenditure for the user, a level of knowledge of the user for the specified subject area, and wherein the providing of the information about the determined total amounts of energy expenditure for the one or more users includes providing information about the assessed levels of knowledge for the multiple users.

17. The system of claim 16 wherein the multiple users are students learning the specified subject area, and wherein the providing of the information about the assessed levels of knowledge for the multiple users includes providing the information to a teacher of the multiple users, including generating a visual display that has information for the multiple users including at least the assessed levels of knowledge for the multiple users.

18. The system of claim 16 wherein the multiple users are applicants for a job involving the specified subject area, and wherein the providing of the information about the assessed levels of knowledge for the multiple users includes providing the information to an entity involved in hiring for the job.

19. The system of claim 15 wherein the handwriting energy expenditure system includes software instructions that, when executed, further cause the at least one hardware processor to compare, for each of the one or more users, the determined total amount of energy expenditure for the user to total amounts of energy expenditure for other users of the multiple users, and to normalize the determined total amount of energy expenditure for each of the one or more users based at least in part on the comparing, and wherein the providing of the information about the determined total amounts of energy expenditure for the one or more users includes providing information about the normalized determined total amount of energy expenditure for each of the one or more users.

20. The system of claim 15 wherein the handwriting energy expenditure system includes software instructions that, when executed, further cause the at least one hardware processor to combine the determined total amount of energy expenditure for each of the one or more users with additional information of one or more types, the additional information of the one or more types including information about one or more of accuracy of the handwritten information by the user, lexical terms used in the handwritten information by the user, or writing efficiency by the user in producing the handwritten information by the user.

21. The system of claim 15 wherein the handwritten information received from the multiple users is provided using one or more types of devices involved in an evaluation for usability, wherein the handwriting energy expenditure system includes software instructions that, when executed, further cause the at least one hardware processor to aggregate, for a plurality of users of the multiple users that include the one or more users, the determined total amounts of energy expenditure of the plurality of users, and wherein the providing of the information about the determined total amounts of energy expenditure for the one or more users includes providing, to an entity involved in the evaluation, information about the aggregated determined total amounts of energy expenditure of the plurality of users as part of the evaluation.

22. The system of claim 15 wherein the receiving of the handwritten information from one of the one or more users occurs via a graphical user interface displayed on a computing device,
wherein the assessing of the handwritten input further includes determining, based at least in part on the determined total amount of energy expenditure for the one user, to modify the graphical user interface in a determined manner to reduce energy expended while providing future handwritten input, the modifying in the determined manner including changing a portion of the graphical user interface that is used for receiving the future handwritten input,
wherein the providing of the information about the determined total amounts of energy expenditure for the one or more users includes modifying the graphical user interface in the determined manner,
and wherein the system includes a memory with software instructions of the handwriting energy expenditure system that further cause the at least one hardware processor to receive additional handwritten input from the one user in the modified graphical user interface and to use the received additional handwritten input.

23. The system of claim 15 wherein the receiving of the handwritten information from one of the one or more users includes displaying visual representations of the handwritten information of the one user on a computing device,
wherein the assessing of the handwritten input further includes determining, based at least in part on the determined total amount of energy expenditure for the one user, to modify a visual representation of future handwritten input displayed on the computing device, the modifying including changing a size of the visual representation of the future handwritten input to reduce energy expended while providing the future handwritten input,
and wherein the system includes a memory with software instructions of the handwriting energy expenditure system that further cause the at least one hardware processor to display, after receiving the future handwritten input, the future handwritten input on the computing device using the modified visual representation.

24. The system of claim 15 wherein the determining of the one or more stroke signal features of the handwritten information for each of the multiple users includes determining multiple stroke signal features of the handwritten information for each of the multiple users, the multiple stroke signal features including a plurality of stroke pressure, stroke distance or stroke duration, wherein the determining of the total amount of energy expenditure by each of the multiple users includes combining information about the determined multiple stroke signal features of the handwritten information for each of the multiple users without using any other information, and wherein the providing of the information about the determined total amounts of energy expenditure for the one or more users includes providing information about the determined total amounts of energy expenditure for the multiple users.

25. The system of claim 15 wherein the one or more computer systems include multiple client computing devices being used by the multiple users, and wherein each of the client computing devices includes a touch-sensitive area on which handwritten input is received and a display on which visual representations of the received handwritten input are shown.

26. The system of claim 15 wherein the one or more computer systems include a server system that receives information over one or more computer networks from multiple devices being used by the multiple users to provide handwritten input.

27. The system of claim 15 wherein the providing of the information about the determined total amounts of energy expenditure for the one or more users includes generating a visual display that has information for the multiple users including at least the determined total amounts of energy expenditure for the multiple users.

28. The system of claim 15 wherein the handwriting energy expenditure system consists of one or more means for performing the assessing of the handwritten input.

29. A non-transitory computer-readable medium having stored contents that cause a computing device to perform a method, the method comprising:
receiving, by a computing device and from a user, handwritten information related to a specified subject area;
determining, by the computing device and based at least in part on one or more stroke signal features of the handwritten information, a total amount of energy expenditure by the user in generating the handwritten information;
assessing, by the computing device, based on the determined total amount of energy expenditure and without using any content of the handwritten information, a level of knowledge of the user for the specified subject area, including comparing the determined total amount of energy expenditure for the user to one or more other amounts of previously determined energy expenditure from providing other handwritten information; and
providing, by the computing device, information about the assessed level of knowledge of the user.

30. The non-transitory computer-readable medium of claim 29 wherein the one or more stroke signal features include multiple stroke signal features that include a plurality of stroke pressure, stroke duration or stroke distance, wherein the computing device includes an input area on which the handwritten information is received from the user and includes a display screen on which information is displayed to the user, and wherein the stored contents include software instructions that, when executed, further cause the computing device to:
before the receiving of the handwritten information, display information to the user on the display screen; and
after the assessing of the level of knowledge of the user, dynamically modify a further display of information to the user on the display screen based at least in part on the assessed level of knowledge.
